(19) United States
(12) Patent Application Publication
(10) Pub. No.: US 2009/0170444 A1
(43) Pub. Date: Jul. 2, 2009

(54) Software defined radio with configurable multi-band front-end

(76) Inventors: Francis Emmanuel Retnasothie, Markham (CA); Mehmet Kemal Ozdemir, Pickering (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/003,510

(22) Filed: Dec. 26, 2007

(51) Int. Cl. H04B 1/38

(52) U.S. Cl. 455/73

(57) ABSTRACT

A software defined radio (SDR) for communicating a plurality of radio signals over a wireless communications network. The radio comprising: a programmable system having a plurality of digital processors for processing digital data representing a digital form of the plurality of radio signals, the programmable system also for configuring operation of radio hardware for processing of the radio signals themselves; a configurable intermediate frequency (IF) interface for processing the plurality of radio signals for subsequent processing as the digital data communicated to the programmable system and the digital data received from the programmable system, the IF interface having a first connector for releasably connecting a modular IF filter component for use in the processing of said plurality of radio signals, the modular IF filter component being part of the radio hardware for selecting an IF center frequency and channel bandwidth of the SDR; and an RF platform coupled to the IF interface and configured for having with at least one radio portion, each radio portion for receiving and transmitting the radio signal over the communications network on behalf of the IF interface, said each radio portion having a second connector for releasably connecting a modular RF filter component for use in the processing of said plurality of radio signals, the modular RF filter component being part of the radio hardware for selecting an RF sub-band and RF center frequency of said each radio module; wherein the programmable system is adapted to configure operation of the SDR through recognition of the corresponding connected modular RF and IF filters.

### FIELD OF THE INVENTION

This invention relates to processing of communicated radio signals using a combination of software and hardware components.

### BACKGROUND OF THE INVENTION

Contemporary telecommunications technologies are unfortunately manufactured to be carrier, IF (intermediate frequency) and RF (Radio Frequency) bandwidth dependent, such as CDMA (code-division multiple access) and GSM (global system for mobile) that serve most of today's cell phones as well as other less portable wireless radios. Further, even some of today's SDR (software defined radio) radios also have these unfortunate dependencies. These dependencies necessitate radio and cell phone manufacturers (i.e. wireless device manufacturers) to manufacture a variety of different wireless devices for each carrier, IF, and bandwidth combination. These device varieties can exist for multiple carriers within a particular country, as well as for different carriers in different countries, in view of the multitude of segmented RF and microwave spectrum available globally. Further, in the event of a network wireless communication upgrade to a new communication protocol (or standard), such as 2G to 3G to 4G, new wireless devices must be produced to take advantage of the new features of the upgraded network, in essence making the existing wireless devices obsolete.

The disadvantage of having carrier, IF and RF bandwidth dependent configured wireless devices has been compounded in recent years due in part to advances in digital signal processing capabilities and in part to more and more traditional analog radio spectrum being freed for digital transmission (i.e. an increase in the wireless spectrum available to the carriers). The recent FCC auction of 700 MHz is a good example of the increase in available spectrum for wireless communication. It is anticipated that these trends will continue for the availability of spectrum for broadband wireless communication as well as for digital signal processing capabilities and functionality.

In recent years, the SDR has been the aim in radio development. One initiative named the Joint Tactical Radio System (JTRS) has looked at this type of radio for military applications and others have looked at the SDR for many other applications in the commercial arena as well. As the majority of the radio can be contained within the software for SDR, the hope is that physical upgrades for users for applications such as the change from the 2G to 3G cellular systems would simply consist of a software upgrade, leaving the hardware untouched. However, in view of the availability of global frequency spectrum, it is considered impractical to be able to support all variations for carrier, IF, and RF bandwidth dependencies within a single wireless device.

Therefore, connectivity is major issue for wireless devices, as all radios need to have both an over-the-air interface at the radio signal frequency, and also at the base-band interface. With most transmissions that occur these days carrying digital data, rather than analog signals, it is necessary to use the right data formats and exchange communication protocols. This is particularly important for global roaming using mobile equipment. As different standards are used in different areas it is necessary to be able to cater for different ones dependent upon the area where the wireless device equipment is to be located.

### SUMMARY OF THE INVENTION

It is an object of the present invention to provide a multi-band enabled software defined radio platform to obviate or mitigate at least some of the above-presented disadvantages.

One aspect provided is a software defined radio (SDR) for communicating a plurality of radio signals over a wireless communications network, the radio comprising: a programmable system having a plurality of digital processors for processing digital data representing a digital form of the plurality of radio signals, the programmable system also for configuring operation of radio hardware for processing of the radio signals themselves; a configurable intermediate frequency (IF) interface for processing the plurality of radio signals for subsequent processing as the digital data communicated to the programmable system and the digital data received from the programmable system, the IF interface having a first connector for releasably connecting a modular IF filter component for use in the processing of said plurality of radio signals, the modular IF filter component being part of the radio hardware for selecting an IF center frequency and channel bandwidth of the SDR; and an RF platform coupled to the IF interface and configured for having with at least one radio portion, each radio portion for receiving and transmitting the radio signal over the communications network on behalf of the IF interface, said each radio portion having a second connector for releasably connecting a modular RF filter component for use in the processing of said plurality of radio signals, the modular RF filter component being part of the radio hardware for selecting an RF sub-band and RF center frequency of said each radio module; wherein the programmable system is adapted to configure operation of the SDR through recognition of the corresponding connected modular RF and IF filters.

A second aspect is a software defined radio (SDR) method for communicating a plurality of radio signals over a wireless communications network, the method comprising: configuring operation of the SDR through dynamically recognizing frequency characteristics of a modular IF filter component and a modular RF filter component from corresponding filter identification information; generating digital data through a programmable system having a plurality of digital processors, the digital data for representing eventual content of a radio signal, the programmable system configured for operation of radio hardware for processing of the radio signal; converting the digital data as content for the corresponding radio signal; processing the radio signal though the modular IF filter component, the modular IF filter component being part of the radio hardware for selecting an IF center frequency and channel bandwidth of the SDR and being releasably connected to a first connector; receiving the processed radio signal from the modular IF filter component and implementing further processing of the received radio signal through the modular RF filter component to generate a transmission signal, the modular RF filter component being part of the radio hardware for selecting an RF sub-band and RF center frequency of the SDR being releasably connected to a second connector; and communicating the transmission signal to the communication network.

A further aspect provided is a digital system for configuring a software defined radio (SDR) adaptable for communicating a radio signal over a communications network, the SDR adaptable for having a plurality of radio portions and an IF interface, each of the radio portions adapted to select an RF sub-band and RF center frequency by a connector for releasable securing a corresponding modular RF filter component, the IF interface having at least one an IF bandwidth and IF center frequency compatible with the selected RF sub-band and the selected RF center frequency, the system comprising: a workflow engine module configured for coordinating operation of a programmable system coupled to the IF interface, the programmable system adaptable to operate the IF interface and the radio portions and to digitally process digital data communicated with the IF interface; a validation module configured for confirming that modular RF filter component after being connected has an acceptable RF sub-band and RF center frequency; a protocol module adapted to configure the SDR for use of a communications protocol compatible with the validated modular RF filter component; and an identification module configured for monitoring which of the plurality of radio portions corresponds with the communicated radio signal.

### BRIEF DESCRIPTION OF THE DRAWINGS

Exemplary embodiments of the invention will now be described in conjunction with the following drawings, by way of example only, in which:

FIG. 1 is a block diagram of a software defined radio environment;

FIG. 2 shows an example software defined radio framework of the environment of FIG. 1;

FIG. 3 shows a further embodiment of the framework of FIG. 2;

FIG. 4 shows example frequency characteristics used by the software defined radio framework of FIG. 2;

FIG. 5A and FIG. 5B are block diagrams of an example filter component of the software defined radio framework of FIG. 2;

FIG. 6 is a block diagram of example mounting interfaces for the filter components of FIGS. 5A and 5B;

FIG. 7 shows an example implementation of the framework of FIG. 2;

FIG. 8 is a block diagram of a digital communication interface between a programmable system 202 and components of the framework of FIG. 2;

FIG. 9A shows a block diagram of an embodiment of an RF front end of the framework of FIG. 2;

FIG. 9B shows a block diagram of a further embodiment of the RF front end of the framework of FIG. 2;

FIG. 9C shows a block diagram of a further embodiment of the RF front end of the framework of FIG. 2;

FIG. 9D shows a block diagram of a further embodiment of the RF front end of the framework of FIG. 2;

FIG. 10A shows a block diagram of a receiving portion of an IF interface of the framework of FIG. 2;

FIG. 10B shows a block diagram of a transmitting portion of the IF interface of the framework of FIG. 2;

FIG. 11 shows a block diagram of a frequency synthesizer system of the IF interface of the framework of FIG. 2;

FIG. 12 is a block diagram of a digital-analog conversion system of the IF interface of the framework of FIG. 2;

FIG. 13 is a block diagram of the programmable system 202 of the framework of FIG. 2;

FIG. 14 is a block diagram of an example engine of the programmable system 202 of FIG. 3;

FIG. 15 is a block diagram of an example computing device of the environment of FIG. 1; and

FIG. 16 is a flowchart of operation of the environment of FIG. 1.

### DETAILED DESCRIPTION OF THE PREFERRED EMBODIMENT(S)

### Software Defined Radio Environment 10

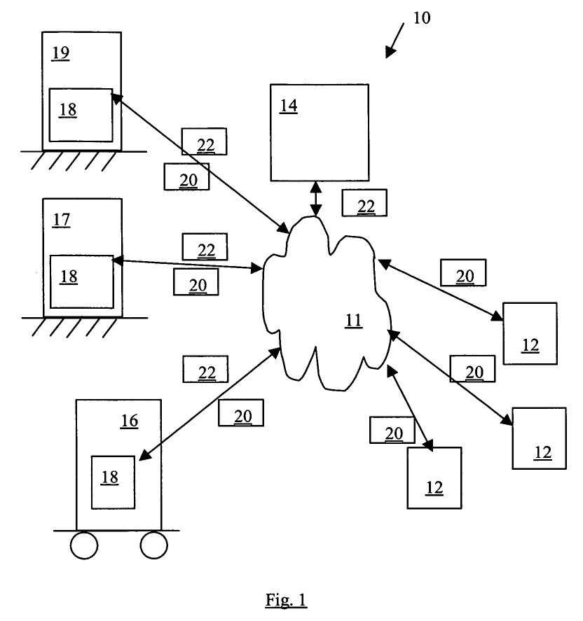

Referring to FIG. 1, shown is a software defined radio (SDR) environment 10 that enables wireless communication devices 16,17 to be dynamically programmed through software (e.g. programmed digital processor and memory systems 202 via executable instructions of an SDR 18) to reconfigure the signal communication and transmission characteristics of devices 16,17. The digital system 202 and one or more modular filter hardware components 200 are included in the SDR 18, which can be either part of the device 16,17 or can be connected to the device 16,17 via a communication interface 400 (see FIG. 13). It is recognised that the system 202 is dynamically configurable so as to be consistent with the installed modular filter hardware components 200 and vice versa. One advantage of the SDR 18 is that the same radio hardware can be modified via the programmable system 202 to perform different functions at different times (e.g. commercial application, public safety priority application, repeater for received/transmitted radio frequency (RF) signals 20a with one or more particular communication protocol(s), etc.) which can facilitate a device manufacturer to concentrate development efforts on a common underlying hardware platform. The signals can contain data such as but not limited to: image; video; audio; text; and command/execution instructions.

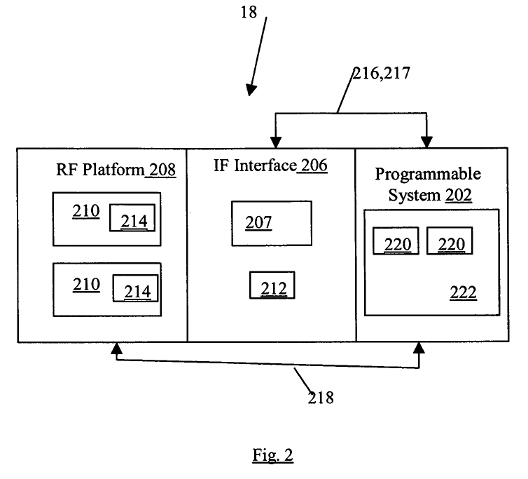

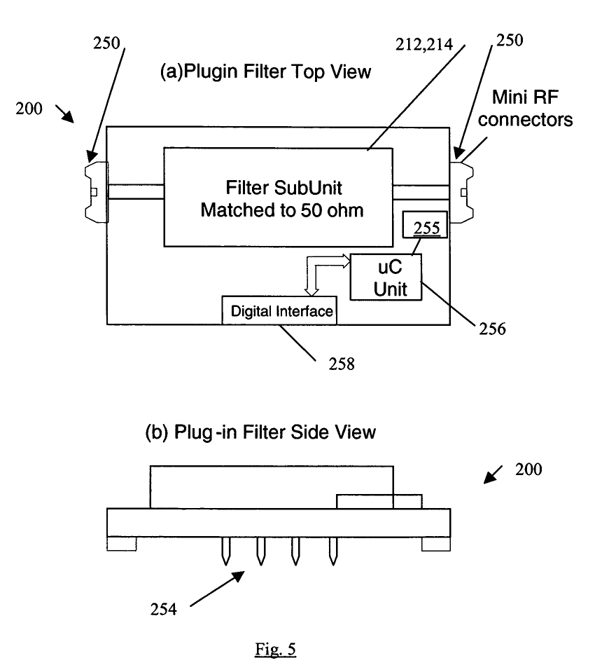

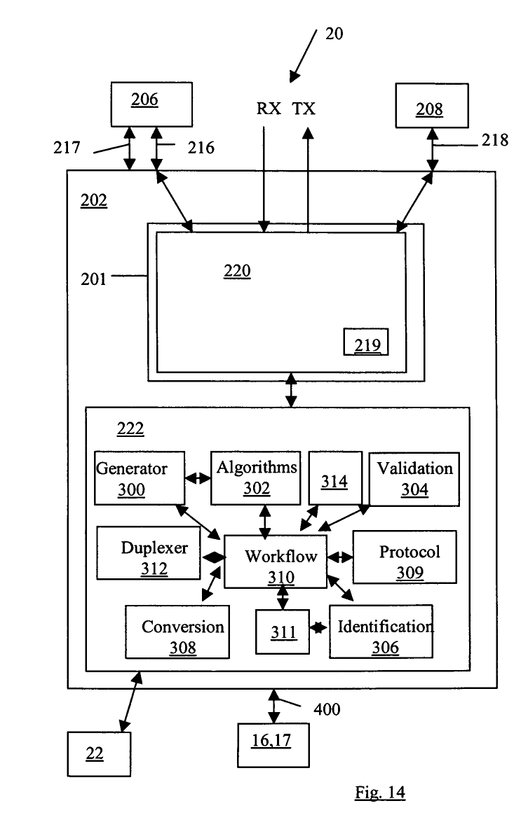

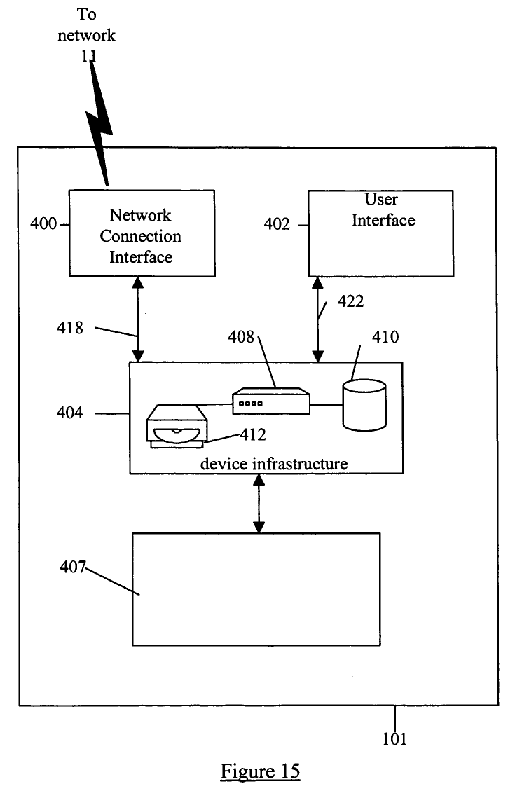

Further, the environment 10 also provides for a substitution/extension ability (e.g. add or remove plug-ins) of the modular filter (e.g. RF, IF) hardware components 200 as hardware components that can be releasably connected to the corresponding module connection interfaces—see FIGS. 5,6—provided by common elements of the SDR 18, in order to reconfigure the radio filter hardware of the devices 16,17 for particular radio frequency (RF) bands/frequencies, intermediate frequency (IF), and/or bandwidth (e.g. particular sub-bands/frequencies) dependencies. It is also recognised that the use of the modular filter hardware components 200 can facilitate the scalability of the SDR 18, which can be dynamically configured by the system 202 according to the particular modular filter components 200 installed. The programmable system 202 can also be reconfigured (e.g. changed, upgraded and/or enhanced) simply by changing the executable instructions by a user of the device 16,17 (via an interface 400—see FIG. 14) and/or can be reconfigured over a network 11 by reconfiguration data 22 received by the device 16,17 from a configuration server 14. Therefore, the SDR 18 has the capability to accept remotely downloadable reconfiguration data 22 (e.g. images, executable instructions) from the network 11 for the communications technology to be used/upgraded by an RF platform and/or IF interface 206 (see FIG. 2), and/or via onboard connectors (e.g. the interface 400) to support local downloads of the reconfiguration data 22 from the device 16,17.

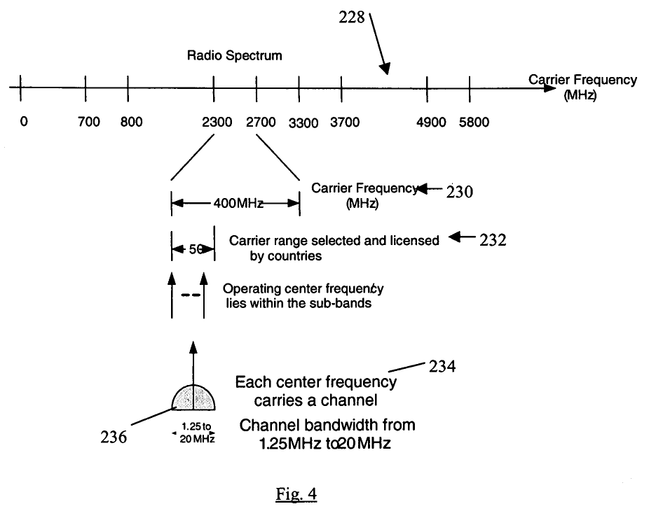

Referring again to FIG. 1, the environment 10 has a number of signal sources/targets 12 that communicate signals 20a (including data with a specific wireless communication protocol) with the wireless devices 16,17 over the wireless communication network 11. The network 11 can support a variety of broadband wireless transmission and reception of the signals 20a, including communication technologies such as but not limited to: WiMAX (Interoperability for Microwave Access); LTE (Long term evolution); WCDMA (Wireless CDMA); UMB (Ultra Mobile Broadband); UMTS (Universal Mobile Telecommunications Service); and other communication modes as desired. It is recognised that WiMAX, LTE, and UMB are based on OFDM (Orthogonal frequency division multiplexing). Further, it is recognised that the scalability of the SDR 18 for future communication technologies (e.g. communication protocols and data/signal formatting) can come in different frequency bands 232 (see FIG. 4), channel bandwidths 236, new filter 200 hardware technologies, and/or new digital signal processing/generation technologies 202. For example, the support for new frequency bands 232 by the SDR 18 can be done via the new or additional RF based modular components 200, while the support for different channel bandwidth 236 and technologies can be done via plug-in IF based modular components 200 and software/hardware upgrade of the systems 202. Referring to Appendix A, provided are current frequency spectrums defined in a number of different countries for communication of the wireless signals 20a over their respective networks 11.

The wireless devices can be portable devices 16 (e.g. handheld devices or connected to a vehicle) or stationary devices 17 (e.g. communication center and/or base station equipment). It is recognised that the application of the SDR 18 with the devices 16,17 can depend upon power requirements of the SDR 18 as well as acceptable manufacturing costs of the device 16,17 incorporating the SDR 18. For example, most observers believe that SDR 18 enabled cell phone devices 16 may not become available to the general public until after 2010, when the increasing availability of mass-produced chip sets may stimulate growth of SDRs 18 into the cell-phone arena. In the meantime, consumer-level SDR 18 terminals can be made available in less power-challenged mobile devices 16,17, such as wireless enabled laptops and within vehicles. Further, it is recognised that the stationary devices 17 can be base stations 19 that are protocol-aware and are capable of bridging otherwise-incompatible networks 11 and/or groups of devices 16,17 through the dynamically configurable systems 202 and the interchangeable filter hardware components 200. the base-stations 19 can operate as a server in a client server relationship with the available clients (e.g. devices 16,17) over the network 11.

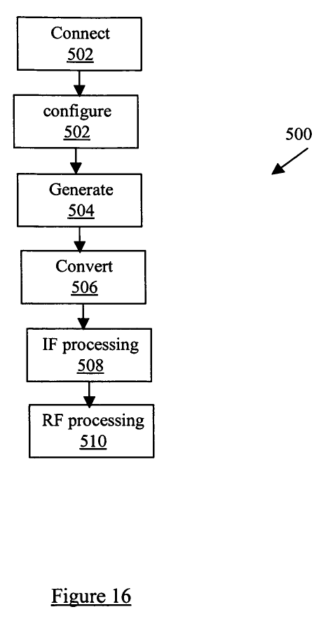

For example, in view of the standard interface 400 (e.g. cPCI, ATCA, microATCA, VME, etc.—see FIG. 14), the SDR unit 18 can be ported into different environments (e.g. PDAs, desktops, and other computing devices 101—see FIG. 15) that are compatible with this same interface 400 (see FIG. 14). The SDR unit 18 can therefore be used in applications such as but not limited to: SS's; BS's; land vehicles; marine vehicles; air vehicles; and CPE's.

Accordingly, the environment 10 can help to provide an efficient and comparatively inexpensive solution to the problem, for example, of building multi-mode, multi-band, multi-functional communications devices 16,17 that can be enhanced using system 202 upgrades (e.g. through software module upgrades) and reconfigured by interchanging/extending the filter hardware modular components 200. It is recognised that the SDR 18 can be configured to function independently of carrier frequencies and can operate within a range of transmission-protocol environments. For example, the SDR 18 can perform upconversion and downconversion between the systems 202 (e.g. baseband) and the filter hardware components 200 in the digital domain (at least in part under the control of the systems 202) and reduce the RF Plafform 208 (see FIG. 2) to a transmit-channel power amplifier with a low-noise amplifier for the receive path and reduced/absent analog filtering.

### SDR 18

In order to support all bands and bandwidths mentioned below, by example, without significant hardware changes of the SDR 18, a hardware configuration of the SDR 18 is implemented by the introduction of plug-in IF and RF filter components 200 for one or more given center frequency 234 and associated RF sub-bands 232 and IF channel bandwidths 236 (see FIG. 4).

The SDR 18 utilizes analog RFEs (RF front ends) for upconversion and downconversion to an IF value that converters can handle. The SDR 18 also employs a wideband Analog to Digital Converter (ADC) that captures all of the channels of the software radio node. The SDR 18 can then extract, downconvert and demodulate the channel waveform using software using programmed digital processors of a programmable system 202. Accordingly, the SDR 18 contains a number of basic functional blocks as a framework. The SDR 18 framework can be split into three basic blocks, namely an RF front end section 208, an IF section 206 and a base-band section 202, as described below. Each of the sections can undertake different types of functions and therefore is likely to use different circuit/processing technologies.

Referring to FIG. 2, the SDR 18 can have three subsystems, namely: the common block (for all digital signals 20b) consisting of digital processing by the programmed digital processor and memory systems 202; a common block (for all analog/digital signals 20a,b) consisting of Analog/Digital conversion, up/down conversion 207 and common IF filtering of an intermediate interface system 206 that includes one or more IF filter modules 212; and a radio platform 208 for housing one or more radio portions 210 (specific to predefined operation frequencies of each of the received/generated analog RF signals 20a) that are configurable to be frequency band specific, and center frequency specific, such that each of the radio portions 210 includes one or more RF filter modules 214. It is recognised that the IF filter 212 are matched somewhat to the RF filter 214 modules (e.g. such that IF filter center frequency 236 is greater than a specified percentage of the RF center frequency 236) to comprise the modular filter hardware components 200 of the SDR 18. As discussed further below, the modular filter (e.g. set of RF 212 and IF 214 filters) hardware components 200 facilitate the reconfiguration of the SDR 18, for transmission/reception, for specific carrier (e.g. particular RF bands/frequencies), IF frequency/frequencies, and corresponding bandwidth (e.g. particular sub-bands/frequencies) dependencies, as desired.

### Programmable System 202

The SDR 18 performs significant amounts of signal 20a processing digitally (using signal 20a in a downconverted and digitized form as the digital signal 20b) in a general-purpose computer 101 (see FIG. 15) or other equivalent reconfigurable piece of digital electronics provided by the system 202, in order to implement the required radio functions to transmit and receive the signals 20a. It is recognised that the SDR 18 is connected to a user interface (e.g. user interface 402—see FIG. 15) via the digital interface 400. The radio functions are implemented with appropriately configured communication/data format protocols (matching the communication protocols inherent of the signals 20a) being accommodated and the data payload of the signal 20a assembled or disassembled from the communicated datastream (by recognising/matching the data formatting of the signals 20a). The system 202 (also referred to as a baseband processor) facilitates operation of the SDR 18 as a radio that can receive and transmit a new/modified form of radio protocol. With most signal 20a transmissions that occur these days carrying digital data, rather than analog data, it is necessary to use the right data formats and communication exchange protocols (e.g. of the network 11). This can be facilitated via the programmable system 202 of the SDR 18, because it is possible to enable the wireless device 16,17 to communicate over the network 11 with a new set of users simply by uploading another software module that configures the programmable system 202 to enable signal 20a exchanges using the appropriate new/modified communication protocol and/or data formatting. For example, it would be possible using the programmable system 202 to add the additional functionality for any new standards using different software modules for configuration of digital blocks 220 that are part of a processing/monitoring engine 222 (see FIG. 14). Interoperability is another issue. As so much of the SDR 18 is contained within programmable system 202, it is possible to integrate other associated software functions into the SDR 18 more easily. Thus one aim may be to integrate other third party software applications (not shown) into the basic SDR 18, thereby increasing its functionality.

The baseband processor system 202 of the SDR 18 implements fully configurable digital processor blocks 220 (e.g. field programmable gate arrays (FPGAs) and/or digital signal processor arrays (DSPs)). For example, FPGAs facilitate the break down of the signal 20b processing/generation into multiple parts to perform relatively simple operations in parallel at required processing speeds, while DSP-based architecture connects multiple DSPs in parallel as DSP blocks to perform the signal 20b processing/generation. It is recognised that the programmable system 202 can also have general purpose processors that are not dedicated to certain specific digital processing/generation of the signals 20b.

The digital blocks 220 can be configured/programmed based on the communication technology/protocol implemented (as well as for monitoring/controlling 216, 218 (of the specific filter modules 214, radio module 210, filter modules 212, conversion components 207) and to perform digital operations such as but not limited to: digital upconversion; digital downconversion; peak-to-average power reduction; pre-distortion compensation; and digital filtering. Depending on the communication technology and specific radio hardware used in the SDR 18, the operational parameters of these blocks 220 are configured accordingly. For example, the programmable system 202 can have significant utility for the military, commercial, and cell phone services, all of which can be called to serve a wide variety of changing radio communication protocols in real time. It is also recognised that the digital blocks 220 can be releasably connected to the programmable system 202 by use of corresponding connection interfaces 201 (see FIG. 14) (e.g. pin/socket connections). The digital blocks 220 could also have identification 219 that could be interpreted by the engine 222 for dynamically configuring of the SDR 18, for example to upgrade or otherwise account for matching with the frequency characteristics of the IF interface 206.

Further, the programmable system 202 can be used to define channel modulation waveforms via a waveform generator 300 (see FIG. 14), that is, the waveforms are generated as sampled digital signals 20b. These sampled digital signals 20b are then converted from digital 20b to analog 20a via a wideband DAC conversion 207 (of the IF interface 206) and then possibly unconverted from IF to RF for communication over the network 11 by the RF platform 208. Further, it is recognised that the programmable system 202 is responsible for the digital generation of the transmitted signal 20b and monitoring the tuning and detection of the received radio signal 20a. For example, functionality of the programmable system 202 can include monitoring/processing of: CDMA tasks such as correlation on 8-bit I/Q data (I/Q meaning in-phase/quadrature), channel-selection, data multiplexing, data packing, gating, triggering, and SDRAM-control functions via processing algorithms 302 (see FIG. 14). Further, the digital blocks 220 can be used to implement custom algorithms on top of factory-installed functions. Various IP (intellectual-property) cores, such as FFTs, pulse-compression algorithms, and wideband digital receivers functionality are also possible, as the processing algorithms 302, along with libraries of device drivers and functions.

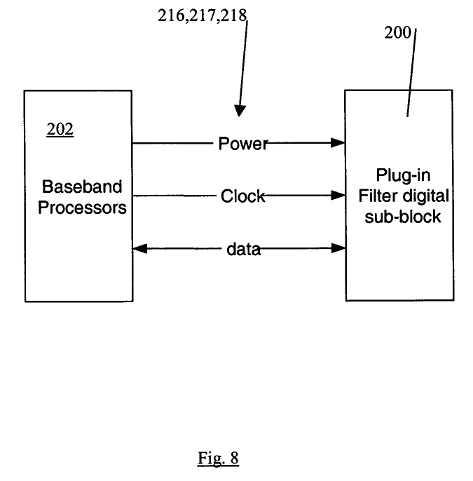

The software modules (e.g. reconfiguration data 22—see FIG. 1) can be compatible with SCA (Software Communications Architecture), developed as a standard for defining the valid formatting and content of executable instructions of the software modules. One implementation of the software modules for configuration/monitoring of the programmable system 202 (e.g. the cognitive engine 222—see FIG. 14) is via the control/monitoring interfaces 216, 217,218 (see FIG. 2) shown in FIG. 8, for example, for interaction with the plug-in filter components 200 and other configurable/monitorable components of the SRD 18. For example, with the above interfaces 216,218, the filter components 200 may not need additional powering since they can get power from the baseband programmable system 202 via the interfaces 216,217,218 (e.g. in the case where the design of the units 256 is as low power devices that are compatible with power available from the processing system 202). When the filter component 200 is powered, at each clock rising or falling edge (e.g. of the programmable system 202 as a whole or for specified blocks 220 of the programmable system 202) for example, a unit 256 sends out the corresponding filter identification data 255 (see FIG. 5) over the digital data pins 254, e.g. serially, as well as including the location of the filter component within the RF platform 208/IF interface 206. It is recognised that the unit 256 can comprise memory for storing the data 255 as well as optional digital processors/microprocessors that are coupled to the programmable system 202 via the interfaces 216,217,218, as discussed.

The baseband programmable system 202 then collects this information (data 255 and location) via a validation module 304 (see FIG. 4) to identify/validate the plug-in filter component 200 and its operational status, for example, as well as other SDR 18 components providing similar information. The data 255 can also be used by the validation engine 304 to determine if the correct filter component 200 is installed in the correct location (e.g. in the IF interface 206 or the RF platform 208).

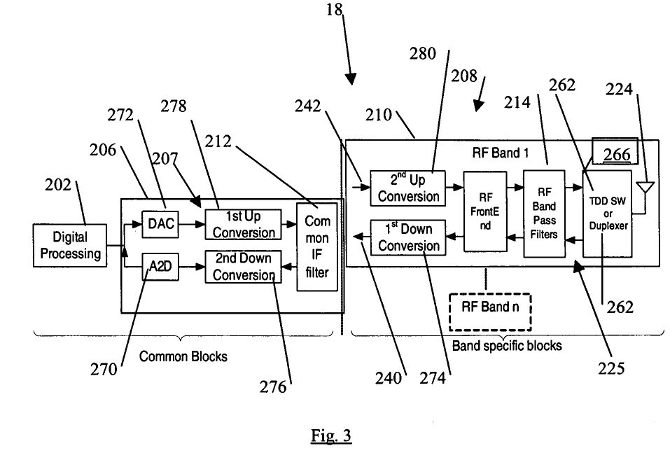

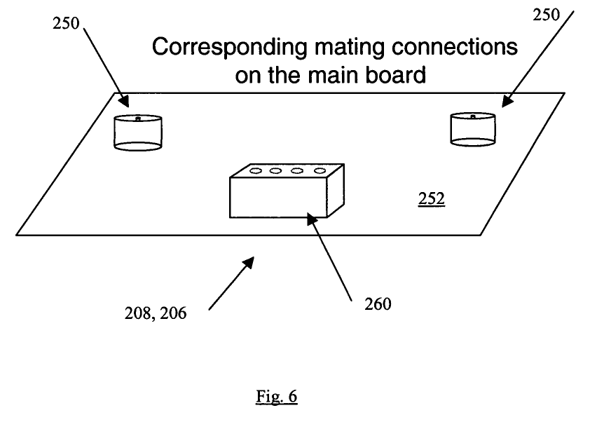

Referring again to FIG. 8, the interface 216, 217, 218 associated with the filter components 200 can also be used to connect to the releasable connection plug-in interface with an FDD (Frequency division duplex) plug-in duplexer 264 or a plug-in TDD (Time division duplex) switch 262 (see FIG. 3) of the radio portions 210. The FDD plug-in duplexer 264 or the plug-in TDD switch 262 have identification/configuration information 266 associated therewith that can be made available to the programmable system 202 (e.g. to the validation module 304) in operation of the inserted plug-ins (e.g. at the moment of plug-in or periodically such as during every clock cycle or series of clock cycles). In terms of RF, the interface 218 can be the same since both have Tx paths 242, Rx paths 240, and antenna 224 ports. In terms of the digital interface 218, however, once the digital line is used to grab (i.e. send the information 266 to the programmable system 202) plug-in information 266 of whether the plug-in is TDD 262 or FDD 264, for TDD 262 the digital line of the digital interface 218 is used for performing the switching as coordinated/monitored by the programmable system 202 (e.g. monitored by a control module 306 that is configured for specific operation of the switch 262 and/or the blocks 220 that are configured to control the actual operation of the switch 262) while for FDD 264 the digital line could remain idle. It is recognised that an example of the interfaces 216,217,218 is the digital interface 258 and corresponding mating connection 260 for the filter components 200, as shown in FIGS. 5 and 6.

Accordingly, the digital programmable system 202, as an example, can be based on a high processing power FPGAs in the blocks 220. The digital programmable system 202 takes digital I and Q data (e.g. digitized from the analog signal 20a or obtained as a digital signal 20b from the interface 400) and performs functions such as but not limited to; filtering, up/downconversion, pre-distortion, peak to average power reduction, digital gain control both in transmitter and receiver, and time and frequency synchronization. The aforementioned processing blocks 220 and below mentioned engine 222 configuration help to improve a given SDR 18 performance as well as to support implementation of different communication technologies/protocols. In addition to the above tasks, the digital programmable system 202 is also responsible for the data transfer protocol (e.g. interfaces 216,217,218) between an SDR card (containing one or more radio portions 210 and/or one or more IF interfaces 206) and a system card (for implementing the programmable system 202 on the computing device 101—see FIG. 15). For example, the interfaces 216,217,218 includes configuration items related to the configuration of the RF platform 208 and/or the IF interface 206 and the TX/RX interfaces include the transfer of I&Q data back and forth between the programmable system 202 and the conversion systems 270,272, for example. Other tasks of the programmable system 202 can include such as but not limited to: configuration of the on-board IC's and their gain control; identification of plug-in units; and TDD switch control. The engine 222 can interface with a flash memory unit (e.g. part of the memory 410—see FIG. 15) that preserves the static information (e.g. configuration) about the programmable system 202, and a DRAM unit (e.g. part of the memory 410—see FIG. 15) to be used for memory consumed in the processing of the digital I&Q data obtained from the signal 20a and intended for transmission in the signal 20a.

### RF Platform 208

The modular RF filters 214 are devices that pass or reject signals 20a by frequency. The RF filter 214 design determines the amount of insertion loss and phase shift for signals 20a that pass through the RF filter 214. For example, bandpass filters 214 are active or passive circuits that pass signals 20a from a specific frequency band 232 (see FIG. 4) and reject signals 20a from out-of-band frequencies. Examples of bandpass filters 214 include surface acoustic wave (SAW) filters, crystal filters, and cavity filters. It is also recognised that the filters 214 can be designed to include band reject filters (bandstop filters, notch filters) that are tuned circuits that prevent the passage of signals 20a within a specified band of frequencies.

The performance specifications for RF filters 214 include specified center frequency 234 and bandwidth 232. Bandwidth 232 is the range of frequencies of the signal 20a that the filters 214 pass with minimal attenuation or, in the case of band reject filters, maximum attenuation. Example configurations for the modular RF filters 214 can include configurations such as but not limited to: SAW filters; BAW filters; and Garnet filters. SAW (surface acoustic wave) filters are electromechanical devices used in RF applications. Electrical signals are converted to a mechanical wave in a piezoelectric crystal; this wave is delayed as it propagates across the crystal, before being converted back to an electrical signal by further electrodes. The delayed outputs are recombined to produce a direct analog implementation of a finite impulse response filter. This hybrid filtering technique is also found in an analog sampled filter. BAW (Bulk Acoustic Wave) filters are also electromechanical devices. These filters can implement ladder or lattice filters. Another method of filtering, at microwave frequencies (e.g. from 800 MHz to about 5 GHz) is to use a synthetic single crystal yttrium iron garnet sphere made of a chemical combination of yttrium and iron (YIGF, or yttrium iron garnet filter). The garnet sits on a strip of metal driven by a transistor, and a small loop antenna touches the top of the sphere. An electromagnet changes the frequency that the garnet will pass. One advantage of this method is that the garnet can be tuned over a very wide frequency by varying the strength of the magnetic field.

Referring to FIG. 3, in an ideal world the signal 20a at the final frequency and at the correct level (for communication over the network 11) would be processed and generated by the programmable system 202. However, this may not be currently possible because of hardware limitations. The digital to analog, and analog to digital conversion may not be sufficiently fast enough to generate signals 20a,b at all frequencies, and the required power levels may not be possible for generation for high power transmitters. Accordingly, one or more of the analog radio frequency elements (i.e. the radio portions 210) are used by the SDR 18, which facilitate the SDR 18 framework to be tuned/configured to specific frequency bands and receive corresponding modulation of the communicated analog signals 20a for selected portions of the large frequency spectrum (see FIG. 4). The radio portions 210 are configured/programmed and monitored by the programmable system 202 and support frequencies (e.g. ranging from DC to 6 GHz) in selectable carrier frequency bands 230 and sub-bands 232 (see FIG. 4) as provided by the plug-in filter modules 214. Accordingly, the radio modules 210 are configured via the filter modules 214 (in FIG. 3) to support a center frequency 234 lying within the RF sub-bands 232. For the support of current and future sub-bands 232, the architecture of the RF filters 214 and supporting RF platform 208 is designed such that they can support selected sub-bands 232 and selected center frequencies 236. It is in this manner of using the plug-in filter modules 214 that the radio portions 210 are tuned to receive and transmit signals of appropriate signal 20a characteristics as expected by the IF interface 206.

Referring to FIG. 3, the SDR 18 with the multi-band RF front end (i.e. RF platform 208) can be used in a variety of applications and equipment for broadband wireless transmission and reception of the signals 20a, using analog RF circuitry 225 for communicating the signal 20a over the network 11 at the operational RF frequency via a coupling of the SDR 18 to the antenna or its feeder 224. The RF platform 208 also communicates the signal 20 to or from the intermediate frequency (or frequencies) used by the IF interface 206. Each of the radio portions 210 can support different operational frequencies for communication technologies/protocols such as but not limited to: WiMAX; LTE; WCDMA; UMB; UMTS; and alike. The multi-band radio portions 210 with their plug-in filter components 214 can support a wide range of applications for the following example carrier frequencies of operation 230, namely ranges 230: 700-800 MHz; 2.3-2.7 GHz; 3.3-3.7 GHz; and 4.9-5.8 GHz (see FIG. 4). For example, each of the radio modules 210 can be configured to operate at each RF band frequency 230 with sub-bands 232 defined based on the region the SDR 18 will be used, as further described below. For example, for 2.3-2.7 GHz band, a sub-band from 2.3-2.4 GHz exists for countries like Malaysia. Similar 50 or 100 MHz sub-bands 232 exist, for example, for all the carrier frequency bands of a radio spectrum 228. It is recognised that the RF platform 208 provides for a common footprint for the RF filters 214 (e.g. via the mounting interface of FIG. 6) and amplifiers 225 for a given RF band to support different sub-bands.

Thus on a receive path 240, see FIG. 3, each of the radio modules 210 is connected to the antenna 224 input using matching circuitry 225 to facilitate the optimum signal 20a transfer at the configured band frequency 236 and bandwidth 232 as band pass filter processed by the RF filter 214. The signal 20a is then amplified and applied to a mixer with a signal from a local oscillator to down-convert it to an intermediate frequency used by the IF interface 206, as further described below. Accordingly, it is recognised that the conversions 274, 280 can be included in the RF platform 208 and/or the IF interface 206.

On a transmit path 242, each of the radio portions 210 takes the signal 20a from the IF, after from the intermediate frequency being first up-converted it to the final band frequency 234 and corresponding bandwidth 236, where it is then amplified to the required level, passed through suitable matching circuitry 225 to facilitate the maximum power transfer and is then presented at the antenna connection to be routed to the antenna 224 either directly or via a feeder.

It is recognised that the standard interface implementation for the plurality of radio portions 210 on the RF platform 208 can make the SDR 18 scalable such that multiple radio portions 210 can be used to serve different needs. Further, either a single SDR 18 can be used for a given single cell, or a multiple of SDRs 18 can be used to serve multiple sectors, such that each of the SDRs 18 can have one or more radio portions 210. As well, scalability for multiple antenna techniques, Col-MIMO, Beamforming, Rx/Tx diversity can be accommodated by the SDR 18 via the implementation of multiple antenna 224 techniques.

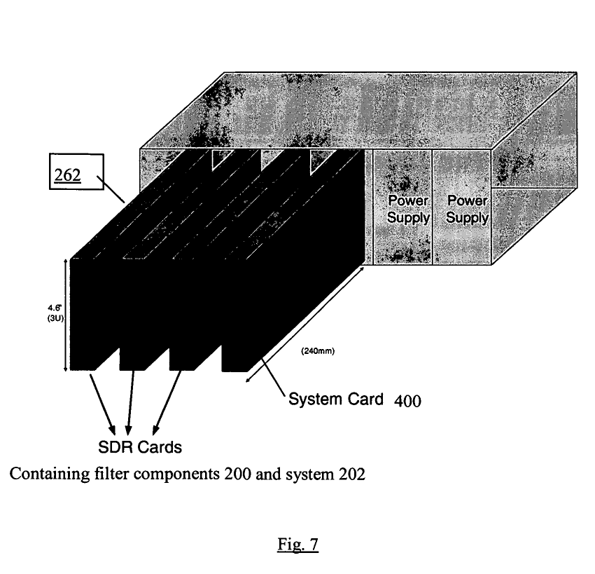

Further, in general, the usage of different filter components 200 for the SDR 18 that operate at different frequencies enables the usage of multiple technologies and multiple frequency of operation at the same time. With this ability, only a single set of SDR unit 18 can be used (e.g. a common RF platform 208, a common IF interface 206, and a common programmable system 202) for the establishment of different technology usage. See FIG. 7 for an example modular design. As well, the SDR 18 can implement a GPS receiver 262 functionality for geospatial location sensing of the SDR 18 unit. Synchronization between SDR 18 units, hand-off, location awareness, and other algorithms can be improved with the usage of the GPS receiver 262 that is monitored or otherwise controlled by the programmable system 202 (see FIG. 3).

In any event, it is recognised that each of the radio portions 210, present in the RF platform 208, can be tuned to a particular center frequency 234 (lying within the sub-bands 232) as configured via the mounted plug-in RF filter modules 214 of the radio portions 210. It is also recognised that at least two of the radio portions 210 in different RF platforms 208 (e.g. different SDR units 18) can have the same mounted plug-in RF filter modules 214 resulting in a similarly provided center frequency 234 lying within the same sub-bands 232. Each of these similarly configured SDR units 18 can be used by the programmable system 202 for different functions/applications (e.g. signals 20a using different communication protocols) in the network 11, as desired. It is also recognised that each of the SDR units 18 can have differently configured RF platforms 208 (e.g. RF filter modules 214), as desired.

Further, referring to FIG. 3, the radio portions 210 can also have the FDD plug-in duplexer 264 or the plug-in TDD switch 262, such that the duplexer 264 configures the corresponding radio portion 210 to operate using frequency division duplexing while the switch 262 configures the corresponding radio portion 210 to operate using time division duplexing.

### IF Interface 206

For signal 20 frequencies above a specified digital processing frequency limit (e.g. above approximately 70 MHz for example), the actual conversion systems 270, 272 do not perform at sufficient conversion speeds so direct-conversion may not be possible. Accordingly, the IF interface 206 can be configured to downconvert the analog signal 20 to lower the frequency of the received signal 20 to intermediate frequency values (IF), and then eventually under the specified digital processing frequency limit. In the receiver path 240, a first downconversion is performed by a downconversion unit 274 (see FIG. 3) and then the downconverted signal 20 is then processed by the band pass IF filter module 212. This IF signal 20 is then processed by a second downconversion unit 276 and then treated by the ADC system 270 for subsequent delivery to the programmable system 202 for digital processing. It is recognised that the number of downconversions can be other than shown (e.g. only one, three, more than three, etc . . . ).

Conversely, in the transmission path 242, a first upconversion unit 278 takes the digital signal 20 from the DAC system 272 and passes it to the IF filter module 212 for respective band pass filter processing. Then, the IF signal 20 is processed by a second upconversion unit 280 and then passed to the RF filter modules 214 of the radio modules 210. It is recognised that the conversion processes 274 and 280 can be performed by either the RF platform 208 or the IF interface 206, as desired. Accordingly, current (2007) digital electronics can be too slow to receive directly typical radio signals over digital processing frequency limit. An example SDR 18 collects and processes signal 20 samples at more than twice the maximum frequency at which the SDR 18 is to operate. It is recognised that the number of upconversions can be other than shown (e.g. only one, three, more than three, etc. . . ) and can also be different than the number of downconversions.

The modular IF filters 212 can be classified into three categories: crystal filter, ceramic filter and SAW filter. It is recognised that the modular IF filters 212 can be similar to the above described RF filter 214 examples with appropriately selected center frequencies 236 and channel bandwidths 234. The channel BW's 236 can be selected from 1.25 MHz to 20 MHz, for example. Although any BW 236 value can be selected within the given range, the most common supported bandwidths 236 are 1.25, 1.5, 2, 3.5, 5, 6, 7, 8, 10, 14, 15, and 20 MHz. The modular IF filters 212, one installed (e.g. releasably connected) facilitate the IF interface 206 to receive/transmit the analog signal 20a with respect to the RF platform 208 (at the RX/TX RF band 232) and to receive/transmit the digital signal 20b (in view of the RX/TX IF sub-bands 236 and center frequencies 234) with respect to the programmable system 202. It is recognised that the RF center frequencies 236 processed by the RF filters 214 can be different from the center frequencies 236 processed by the IF filters 212. Further, if is recognised that the RF sub-bands 232 of the RF filters 214 can be different from the channel bandwidth 236 of the IF filters 212, as desired.

Referring to FIG. 3, the architecture of the SDR 18 can retain a common IF frequency via the IF interface 206 for all the RF band frequencies 234 supported by the corresponding radio modules 210 and their corresponding sub-bands 236. It is recognised that the IF center frequency 234 and bandwidth 236 of the plug-in IF filter modules 212 is selected so as to match/correspond with the corresponding RF center frequency 234 and bandwidth 236 of the plug-in RF filter modules 214.

In general, the IF interface 206 performs the digital to and from analog conversions (to facilitate communication of the analog signal 20a from the radio portions 210 as the digital signal 20b to the programmable system 202 and vice versa). It also contains the processing that undertakes what may be thought of as the traditional radio processing elements, including filtering, modulation and demodulation and any other signal processing that may be required.

On the receive path 240, the signal 20a enters the IF plug-in filter 212 where it is downconverted and then to the ADC system 270, where the signal 20a is then digitized (output as a digital signal 20b) and then processed and demodulated as the baseband signal for processing by the baseband programmable system 202. Similarly on the transmit path 242, the signal 20b arrives from the baseband programmable system 202, is then converted from its digital format to analog using the digital to analog converter system 272, and then the signal 20a is modulated onto the carrier and conditioned as required in conjunction with the IF filter modules 212. It is recognised that the analog-to-digital converter system 270 (abbreviated ADC, A/D or A to D) can be an electronic integrated circuit, which converts continuous signals to discrete digital numbers. The reverse operation is performed by the digital-to-analog converter (DAC) system 272. Typically, the ADC is an electronic device that converts an input analog voltage (or current) to a digital number and the DAC is an electronic device that converts a digital number to an input analog voltage (or current). Further, it is recognised that the ADC and DAC require significant levels of processing. This can be required to perform all the processing on the actual signals in digital format. This processing can be achieved in real time for the systems 270,272 to be able to operate satisfactorily. As a result the processors of the systems 270,272 can be implemented in either stock DSPs or ASICs and/or FPGAs (as an example) and controlled in operation by the interface 216 between the IF interface 206 and the programmable system 202. Accordingly, the full programmability and reconfigurability needed for the SDR 18, the signal processors of the systems 270,272 may be controlled by the programmable system 202 (via the interface 216) in order to facilitate dynamic reconfiguration of the systems 270,270 as needed by the SDR 18 in processed particular signals 20 of specified frequency characteristics (e.g. frequency characteristics 230,232,234,236—see FIG. 4).

In view of the above, it is recognised that the first IF filter module 214 can be a SAW (surface-acoustic-wave) device that tunes the receiver to meet the protocol's blocking-signal specifications, at an IF frequency that is easy to filter but can demand multiple up/downconversion steps (e.g. downconversions 274,276 and upconversions 278,280) to reach practical ADC/DAC system 270,272 signal 20a,b sample rates. It is recognised that the choice of IF filter module 214 frequencies 234,236 can be selected in view of ADC/DAC speed and precision to down/upconverter considerations and/or to the particular choice of frequency characteristics 234,236 of the front-end RF filter modules 214.

It is on this manner of using the plug-in IF filter modules 214 that the IF interface 106 is tuned to receive and transmit signals 20a,b of appropriate signal characteristics as expected by the RF platform 208 (i.e. signals 20a) and the programmable system 202 (i.e. signals 20b).

### Example Filter Component 200 Configuration

Referring to FIGS. 3, 5, 6, at high frequencies, reliable and effective RF-RF and IF-IF connections can be an engineering challenge. Reflection at the mating surfaces between the modular filter components 200 and the plafform/interface 208, 206 can severely attenuate the signals (both RF signal 20a version and the intermediate frequency signal 20a version) if connections between the RF platform 208 and the RF filters 212 and the IF interface 206 and the IF filters 214 are not matched properly for the signals 20a. In order to mitigate this issue, RF connectors 250, e.g. e.g. MMCX type, are employed for the mating of the plug-in filter component 200 and a main board 252 (e.g. PCB). The plug-in filter components 200 can have the same footprint and pin-outs 254 for IF 212 and RF 214 filters, or can have a different footprint, as desired. Further, the plug-in filter components 200 can have an intelligent unit 256 (e.g. memory and/or a processor) that is connected to the programmable system 202 (see FIG. 2) by a digital interface 258 (e.g. involving the pin-outs connectors 254 as an example of the coupling mechanism of the interface 258 with an interface 260), which provides for validation of configuration information 255 of the filter component 200 by the programmable system 202. For example, the unit 256 can store the following information 255: frequency band 232 of the filter component 200; the center frequency 234; the BW 236 of the filter component 200; and/or any other information (e.g. part number) usable for identification purposes of the filter component 200. The corresponding mating connection interface 258 of the pinouts 254 for the mating interface 260 on the main PCB board 252 (or other equivalent mounting mechanism for the RF platform 208 and the IF interface 206) are shown in FIG. 5 and FIG. 6. Accordingly, cooperation/coupling of the interfaces 258,260 facilitates for digital communication of the configuration information 255 between the filter components 200 and the processing system 202. It is recognised that the interface 260 can be addressed to correspond to its particular location in one of the radio modules 210 of the RF platform 208 or the location of the filter 212 in the IF interface 206.

As can be seen from the FIGS. 5 and 6 by example, the plug-in filter components 200 can have the main filtering module 212,214 matched to 50 ohm (or other resistance), and the digital unit 256 that stores the information 255 about the filter component 200. Because the RF connectors 250 on the plug-in filter component 200 already have ground connection, there can be no need to introduce extra ground connections for the filter component 200. For example, plug-in filter components 200 using differential input/output (i.e., two input and two output lines), the number of RF connectors 250 are 4 all together, i.e. 2 input and 2 output. It is recognised that I/O line number configuration can be used other than as shown. The digital interface 258 can have the ground pins 254 as well as the signal and power pins 254, as desired. It is recognised that the connectors 250 can go up to 6 GHz and hence cover the frequency band spectrum 228 or at least the frequency band 234 selection/portion of the respective filter component 200, for example.

With the architecture shown in FIGS. 3, 5, 6, plug-in filter components 200 with different frequency characteristics can be developed. Hence, different frequency 234 sub-bands 232 and channels bandwidths 236 can be supported for the same main board 252 with only easy addition/removal of the filter components 200. Note that the number of plug-in filter components 200 to be designed can be minimized by having the main filter sub-unit 212, 214 on the plug-in filter component 200 to have the same footprint.

In Appendix B, example plug-in filter components 200 center frequencies 234 and their BW's 236 are given. The table shows examples of available microwave spectrum and bandwidth. Within the available spectrum there can be frequency offsets that enable the specific frequency of operation. As an example for WiMAX applications operating in the 2.5 GHz in the USA, the centre frequency offset can be selected as 2498.5 MHz, bandwidth of 3.5 MHz.

As an example, the RF modular filters 214 are connectorized devices that releasably attach with coaxial or other types of connectors 250. The SDR 18 can use several types of releasably configured connectors 250, such as but not limited to: Bayonet Neil-Concelman (BNC) connectors in applications to 2 GHz; Threaded Neil-Concelman (TNC) connectors featuring a threaded coupling nut for applications that require performance to 11 GHz; Miniature coaxial (MCX) connectors for providing broadband capability through 6 GHz in applications where weight and physical space are limited; Subminiature-A (SMA) connectors that directly interface the cable dielectric without air gaps; Subminiature-B (SMB) connectors that snap into place for frequencies from DC to 4 GHz; Subminiature-P (SMP) connectors rated to 40 GHz; and other connectors including MMCX, Mini-UHF, Type F, Type N, 1.6/5.6, and 7-16 connectors. In any event, it is recognised that the releasably configured connectors do not include surface mount technology (SMT) that mounts electrical components to a printed circuit board (PCB) by soldering component leads or terminals to the top surface of the board, and through hole technology (THT) that mounts components by inserting component leads through holes in the board and then soldering the leads in place on the opposite side of the board.

### Example Radio Modules 210

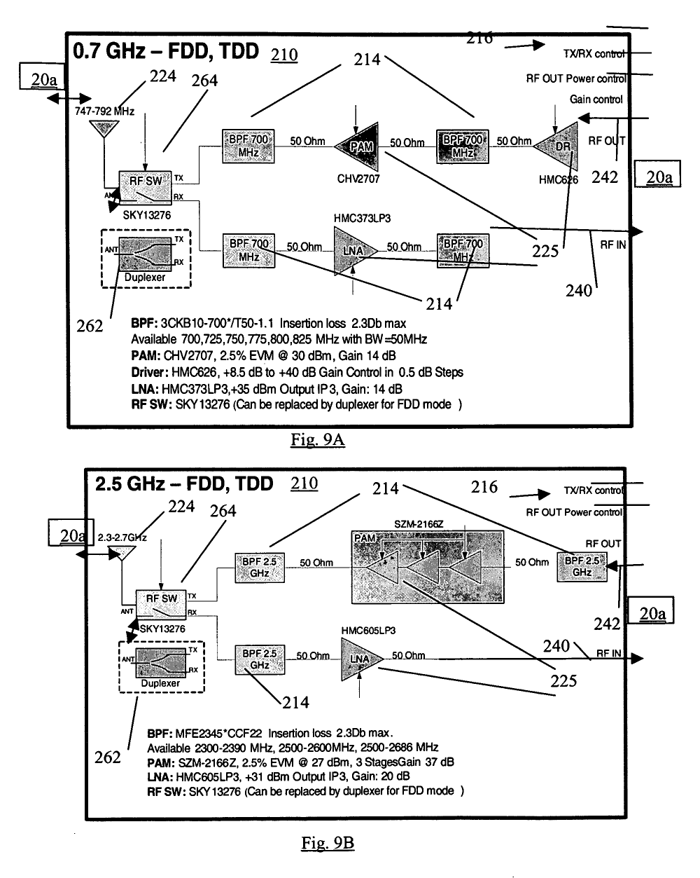

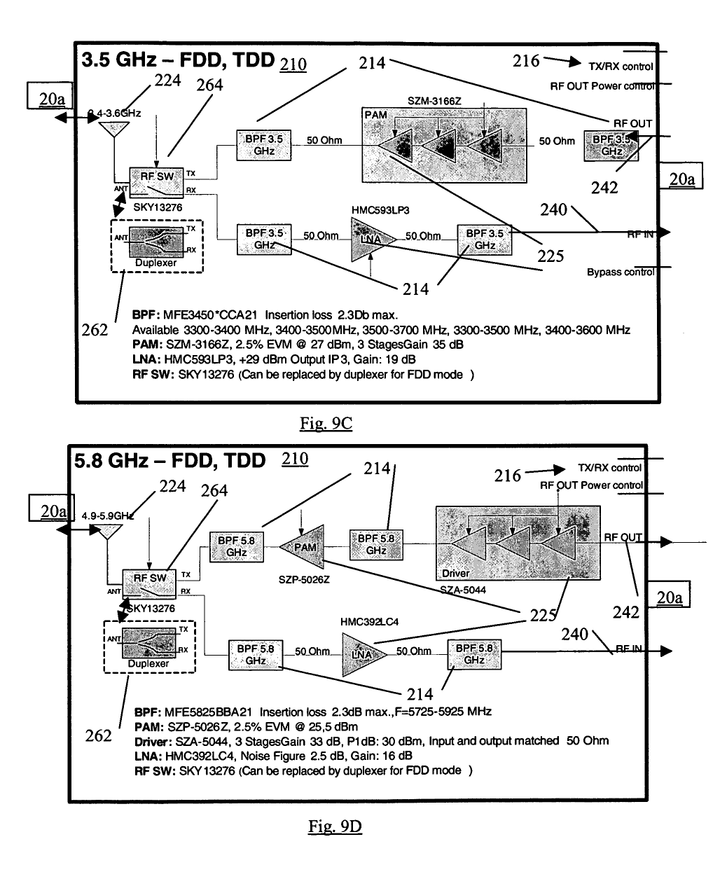

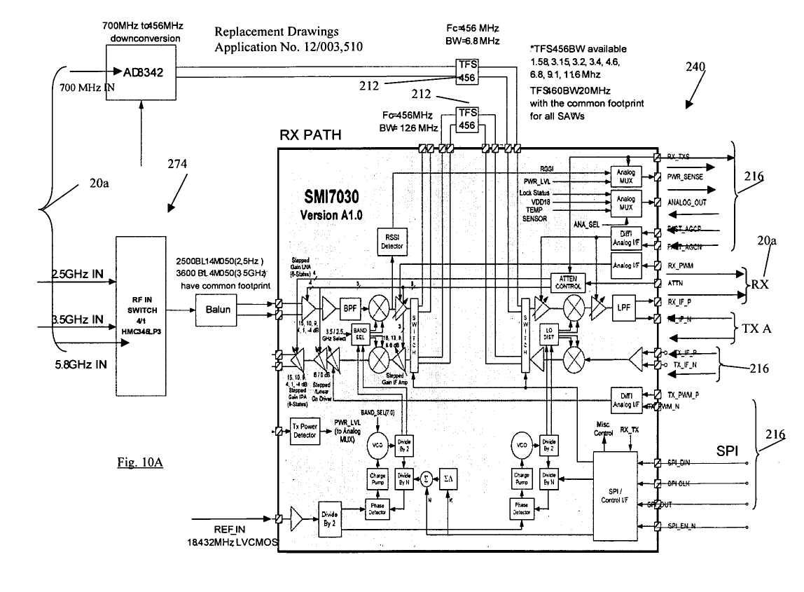

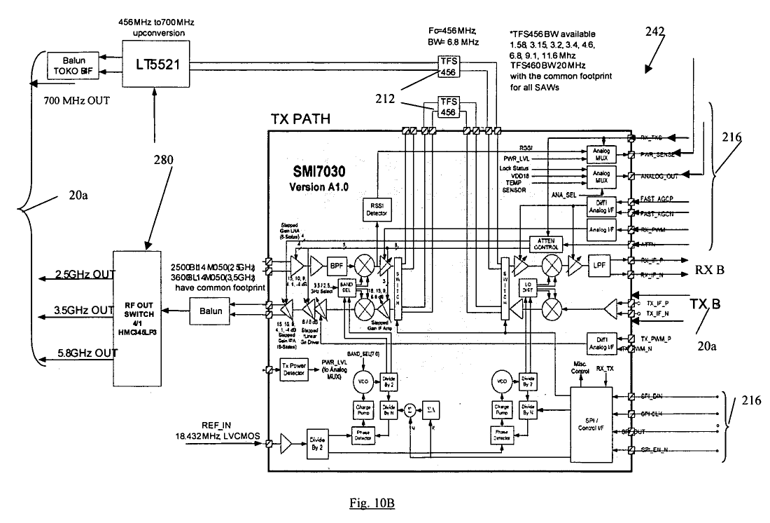

Referring to FIGS. 9A, 9B, 9C, 9D, the multi-band SDR 18 can consist of a plurality of different radio portions 210. Four example types of radio portions 210 can be selected as RF center frequency bands 234 of: 700 MHz; 2.5 GHz; 3.5 GHz; and 5.8 GHz with correspondingly configured sub-bands 236 via the plug-in RF filter modules 214, as shown by example. It is recognised that the RF filter modules 214 can have the center frequency band 234 and sub-bands 232 other than as shown, such as but not limited to further examples given in Appendix C. Further, it is recognised that the RF platform 208 can contain a plurality of radio portions 210 having the center frequency bands 234 and/or sub-bands 232 as configured via the plug-in filter modules 214 that are mounted on the corresponding mounting interface (e.g. board 252 and/or RF connections 250—see FIG. 6) of the radio portions 210.

Each radio portion 210 circuitry has a common architecture to facilitate insertion of customizable plug-ins, such as but not limited to: mounted switches 262; mounted duplexers 264; and mounted RF filter modules 214, as described above. In the transmitter path 242 the PA driver and PA 225 are the common blocks, while in the receiver path 240 the LNA's 225 are the common blocks. Further, it is recognised that the mounting interface (e.g. board 252 and/or RF connections 250—see FIG. 6) can also be considered part of the common blocks of the radio portion 210 (as configured to receive the appropriate customizable elements, the RF filter modules 214 and/or the switches 262 and duplexers 264, having the desired signal 20a analog processing characteristics). Further, both in the transmitter path 242 and the receiver path 240, implemented via the digital interface 216 is: the gain control for a higher dynamic range; bypass control; power detection in the transmitter path 242; Tx/Rx control; switch 264 control; and/or filter module 214 validation/monitoring/control, for example. In any event, it is recognised that the digital communication interface 216 facilitates interaction/monitoring/control between the components of the radio portions 210 and the programmable system 202.

Further, because each radio portion 210 can use a selected sub-band 232 spaning a multitude of RF sub-bands 232 of the spectrum 228 (see FIG. 4), the support of different sub-bands 232 for the communicated analog signal 20a is achieved through the plug-in filter modules 214. Moreover, each radio portion 210 can also support either FDD or TDD operation. While for FDD, the duplexer 264 for a given sub-band 232 is used, for TDD the switch 262 is utilized.

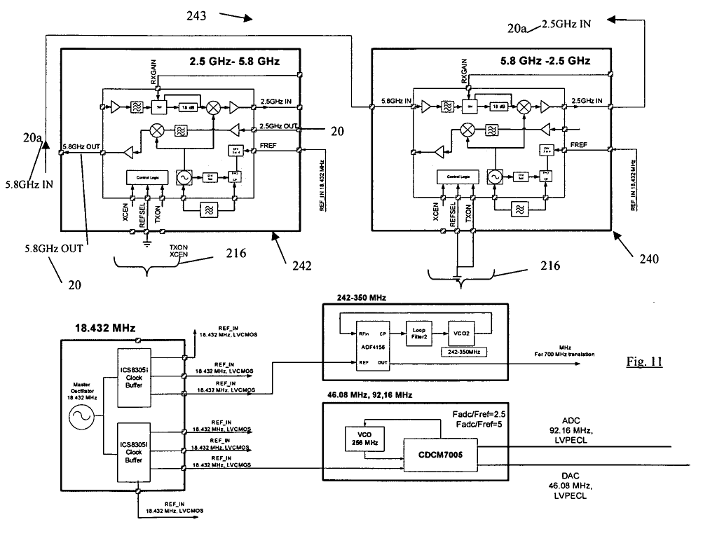

In operation of the radio portions 210, the signals 20a are received by the antennas 224 and then processed by either the switch 264 or duplexer 262 according to the division duplexing mode used. The signals 20a are then processed by the appropriate RF filter modules 214 (e.g. band pass filtered according to the set sub-band 232 of the configured center frequency 234 of the corresponding plug-in filter modules 214), and the other requisite RF circuitry 225 as is known in the art. The filtered signal 20a is then sent as an RF IN signal 20a to the receiver path 240 portion of the IF interface 206 (see FIG. 10A) for downconverting and then subsequent processing by the ADC system 270 and ultimately by the programmable system 202. It is recognised that the programmable system 202 identifies the particular receiving radio portion 210 pertaining to the received signal 20a (or particular transmitting radio portion 210 pertaining to the transmitting radio signal 20a) and notes this via a radio identification module 306 (see FIG. 14) for the subsequent reception/transmission of any signals 20a using the same particular radio portion 210. Otherwise, another radio portion 210 can be used for transmission in the event that the identification module 306 of the programmable system 202 is configured to use a different radio portion 210 (of the same or different sub-band 232 and/or center frequency 234) for transmission of any signals 20a corresponding to the received signal 20a (e.g. a received signal on 700 MHz radio portion 210 can have a corresponding transmitted signal 20a sent out on the 3.5 GHz radio portion 210 (of the same or different SDR 18), or on a 700 MHz radio portion 210 of a different SDR 18).

Similarly, upon transmission of a generated/processed digital signal 20b by the programmable system 202 and after exiting the DAC system 272, described below, the now analog signal 20a is then directed via identification module 306 to the transmission path 242 portion of the IF interface 206 (see FIG. 10B) for upconverting to the appropriate set bandwidth 236 of the configured center frequency 234 as band-pass filtered by the appropriate IF filter module 212 for subsequent reception by the appropriate radio portion 210 of the RF platform 208. It is recognised that the programmable system 202 can dynamically configure the transmission path 242 portion of the IF interface 206 to send the transmission signal 20a to the appropriate radio portion 210. At this stage, the signals 20a are then processed by the appropriate RF filter modules 214 (e.g. band pass filtered according to the set sub-band 232 of the configured center frequency 234 of the corresponding plug-in RF filter modules 214) and the other requisite RF circuitry 225 as is known in the art. Finally, the analog signal 20a is processed by either the switch 264 or duplexer 262 according to the division duplexing mode used and then sent to the antenna 224 for transmission over the network 11 (see FIG. 1).

### Example IF Interface 206

### Receiver Portion 240

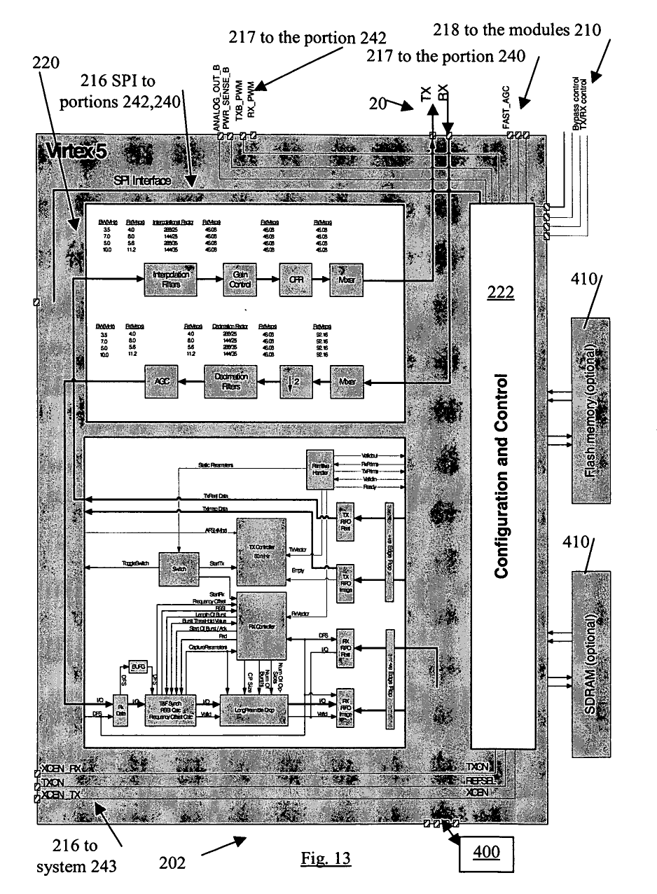

Referring to FIGS. 10A, 10B, 10C, the IF interface 206 is composed of a receiver portion 240 for providing corresponding downconversion processes 274 for the incoming analog signal 20a from the radio portions 210 of the RF platform 208 (see FIGS. 3 and 9A, 9B, 9C, 9D). The downconverted signal 20a is then processed by the plug-in filter modules 212 and then sent via the RX path to the ADC system 270 (see FIG. 12). It is recognised that a variety of component operations of the IF interface 206 for the receiver portion 240 (shown by example in FIG. 10A) can be monitored/controlled via the digital interface 216, 217 which is connected to the programmable system 208 (see FIG. 13).

Further, it is recognised that the receiver portion 240 may have more that one filter module 212 for accommodating the band pass filtering needs for different ones of the radio portions 210. As well, these plurality of filter modules 212 can be used to facilitate direction of the signal 20a from various radio portions 210 to selected sections of the IF interface 206, as controlled/monitored by the identification module 306.

### Transmission Portion 242

The IF interface 206 is also composed of the transmission portion 242 for providing processing by the plug-in filter modules 214 received via the TX path from the DAC system 272 (see FIG. 12), and then the corresponding upconversion processes 280 for the outgoing analog signal 20a to the corresponding radio portion 210 of the RF platform 208 (see FIG. 3 and 9A,9B,9C,9D). It is recognised that a variety of component operations of the IF interface 206 for the transmission portion 242 (shown by example in FIG. 10B) can be monitored/controlled via the digital interface 216, which is connected to the programmable system 208 (see FIG. 13).

Further, it is recognised that the transmission portion 240 may have more than one filter module 212 for accommodating the band pass filtering needs for different ones of the radio portions 210. As well, these plurality of filter modules 212 can be used to facilitate direction of the signal 20a to the various radio portions 210 via selected portions of the IF interface 206, as controlled/monitored by the identification module 306.

Accordingly, the common IF block 206 is separated between transmitter 242 and receiver 240 paths. In the transmitter path 242, it takes the analog signal 20a from the digital to analog system 272 and upconverts this signal 20a into a common IF frequency. This signal is then subsequently upconverted to different RF frequencies for the multi-band operation. In the receiver side 240, the block 206 takes the common IF frequency and downconverts to an analog signal 20a for the analog to digital converter system 270. This way the SDR block is common for all the RF bands up to the IF operation. The IF plug-in filter modules 212 are used after the common IF frequency is obtained (i.e. after process 274 and before process 280). Hence, the common IF block 206 also includes the IF plug-in filter module 212, which can make the IF block 206 independent/common to the particular RF band (e.g. particular frequency characteristics 234,232 of the RF filter module 214) used.

Further, it is recognised that the band pass filters (BPF's) 212 used after the DAC 272 and before the ADC 270, and those used together with digital (e.g. SMI) IC's are all called IF filters 212. Those filters adjacent to the DAC 272 and ADC 270 can be referred to as second IF filters 212, and those adjacent to the RF platform 208 can be referred to as first IF filters 212. Their center frequency 236 can be fixed, and hence their center frequency 236 can be independent of the RF band 232 that the SDR 18 operates on. These filters 212 are responsible for filtering or passing through the channel BW 236 that the SDR 18 operates in, e.g. frequency offsets & sub-band selectivity. Hence these filters 212 also are plug-ins since the SDR 18 supports different channel BWs 236. Note that in this case, the center frequency 236 can be fixed, but width of the signal (i.e. channel BW 236) in the frequency domain around the center frequency 234 can be dynamically selected. The task of these IF filters 212 is to pass only the specific channel BW 236 or reject anything other than the signal BW 236 itself from the signal 20a either going to or coming from the Rf platform 206.

### Frequency Synthesizers and Up/Down Conversion

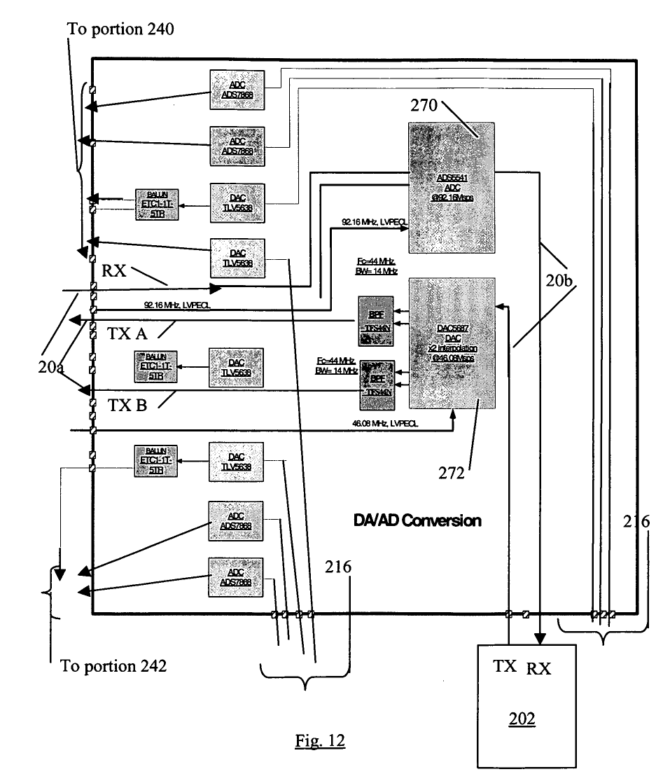

Referring to FIG. 11, the IF interface 206 can also have a frequency synthesizer system 243 for performing frequency synthesis and up/down conversion operation of the SDR 18 in different subsystems. The portions 240,242 given in FIG. 10A,10B do not only introduce common IF frequencies, but also do the frequency synthesis for 2.5 GHz and 3.5 GHz bands, for example. Hence, it also performs the up/down conversion for these bands. For example, the frequency synthesizer system 243 can be used by the identification module 306 to direct the signal 20a to/from the appropriate radio portions 210 over the IF interface 206.

Referring to FIG. 11, for 5.8 GHz band operation, in the transmitter path 242 the output for 2.5 GHz is passed through a frequency converter to get 5.8 GHz band. For the receiver path 242, the same frequency converter unit is used convert 5.8 GHz band to 2.5 GHz. This conversion uses a frequency synthesizer system 243, which is designed to cover the whole 5.8 GHz band. For 700 MHz band, in the transmitter path 242 the common IF frequency is upconverted and in the receiver path 240 a downconversion block is used to get the common IF frequency. It is also recognised that the system 243 can have elements controlled/monitored by the interface 216 by the programmable system 202 (e.g. the identification module 306).

### Analog/Digital Conversion Subsystem

Referring to FIG. 12, the task of digital to analog subsystems 270,272 is to convert digitally processed data of the signal 20 of digital subsystem into an analog signal 20, while the task of analog to digital subsystem is to convert the analog signal 20 into a digital format signal 20 such that the digital subsystem can perform the processing. While the digital data can be in the format of I&Q, the analog data can be a single channel but with differential pair for a better performance. Further, it is recognised that the analog/digital conversion subsystem's sampling frequencies are in synch with the digital subsystem via the interface 217 connected to the programmable system 202, to facilitate that there are no timing issues. Moreover, the subsystem 270,272 can be configured via the programmable system 202 so that multi-technologies are easily supported, including communication via the interface 216 with the receiver 242 and transmission portions 240. It is recognised that the example interface of FIG. 8 can also be used to represent the interface 217, as desired.

### Cognitive Engine 222

Referring to FIGS. 13 and 14, for a given configuration of the SDR 18, the cognitive engine 222 of the baseband programmable system 202 detects the technology or mode of operation to be used of the SDR 18 and then monitors/controls its operation via a workflow engine 310. The workflow engine 310 is used to coordinate processing/generation of various signals 20a,b for different radio portions 210 (e.g. either in parallel or in series depending upon the availability of specific hardware and/or software processes in the SDR 18 for processing of a plurality of the signals 20a,b at various stages), using the plurality of appropriate modules 300, 302, 304, 306, 308, 309 configured for implementing various operations of the engine 222. It is recognised that due to the possibility of a plurality of radio portions 210 being installed in the RF platform 208 of the SDR(s) 18, the workflow module 310 is used to coordinate digital signal processing in by the blocks 220, as well as signal processing and routing of the signal through various stages and subsystems of the RF platform 208 and IF interface 206, as described above. The workflow engine 310 can use a memory 311 that contains a list of all filter components 200 and other plug-in devices that are installed in the SDR 18 for each of the radio portions 210, in coordination of operation of the modules 300, 302, 304, 306, 308, 309. It is recognised that the contents of the memory 311 can be updated (e.g. by the module 310,306), based on any reconfiguration (changing/modification of plug-in components) of the radio portions 210, number of radio portions 210, and of the IF interface 206, for each of the SDR units 18. Further, it is recognised that the memory 311 can store identification, categorization, descriptive, and/or labelling information about the respective stored entities (e.g. filter components 200, other plug-in components, protocols), including one or more libraries for known entities.

For example, the engine 222 can have a protocol module 309 for selecting which defined communication protocol (e.g. stored locally in a memory 410—see FIG. 15) to use in digital processing of the signal 20b, as well as in transmission/reception of the analog signal 20a. Further, the protocol module 309 can cooperate with the validation module 304 (e.g. via the workflow module 310) to confirm that the correct filter components 200 are installed in the RF platform 208 and IF interface 206 for proper implementation of the protocol selected, for processing of a particular received signal 20a as directed by the algorithms module 302. For example, based on the identification module 306 indicating which of the radio modules 210 is being used for communication of the particular received signal 20a, the appropriate protocol is selected by the protocol module 309 and made available to the algorithms module 302 for proper processing of the signal. Further, it is recognised that the workflow module 310 can coordinate operation of the conversion module 308, thereby facilitating dynamic configuration of the conversion systems 270,272 (see FIG. 3) via the interface 217 to accommodate the particular processing characteristics for a particular received/generated signal.

While the technology/protocols can be, for example, any of the technologies/protocols described above, the mode of operation of the SDR 18 can be regular commercial use and/or the usage of public safety. Once the technology(ies) or the mode(s) of operation is/are determined via the workflow module 310, the corresponding image or codes (configuration data 22) are loaded into the baseband programmable system 202 for the operation(s). This configuration can be done on a periodic basis for processing of all received/generated signals and/or can be done on a signal-per-signal basis, as desired. It is recognised that the engine 222 may not use a distinct workflow engine 310, rather the individual modules 300,302,304,306,308,309 can be intelligent and aware of each other and cooperate with one another directly, as desired. Further, it is recognised that the individual modules 300,302,304,306,308,309 can be used to monitor/operate/configure the blocks 220 separately and/or can incorporate at least some of the blocks 220 into their modules, as desired.

Referring again to FIGS. 14 and 3, the engine 222 can be configured to coordinate plug-in filter component 200 validation, as described by the following example. The plug-in filters 200 have a digital interface (e.g. part of the interface 216,218—such as SPI) to report (or otherwise make available) their filter parameters to the validation module 306. The validation module 306 can query all the plug-in filter components 200 in the RF platform 208 and/or IF interface 206 to make sure they are the correct ones, in view of the intended configuration of the SDR 18. The validation algorithm of the validation module 306 can be based on the mode of the card (e.g. of the filter component 214 in the radio module 210) that is set either locally or remotely. By knowing a frequency band 232,234 and the channel BW 236 that the filter component 200 is operating at, the engine 222 can detect any filter components 200 not matching the proper configuration. This mismatch action could then be reported to an administrator of the system 202 (e.g. via a user interface 402—see FIG. 15), such that the mismatches or incorrect configuration is sent to the administrator via remote monitoring and locally by indicating some on-board LED's (e.g. user interface 402). A detection report could also be communicated via the user interface 402, thereby identifying the actual filter components 200 with incorrect configuration. This implementation can help avoid human errors into the SDR 18 configuration and can make the filter components 200 more cognitive about their settings. It is recognised that the user interface 402 can be connected to or otherwise include the interface 400.

### Support for Duplexing

The engine 222 can also support TDD, FDD, and HFDD operation via a duplexer module 312. While TDD operation is established via the wide-band RF switch 264 (see FIG. 9A) within a given radio module 210, due to regulations of different countries, FDD operation can be supported via the duplexer 262 having the same footprint in the RF platform 208, for example. This way for a given regulatory, a required duplexer 262 can be installed/configured in the appropriate radio module 210 for the operation of the SDR 18. HFDD support comes natural once the system supports both TDD and FDD, since HFDD is like FDD except it is half-duplex. The engine 222 can use a duplexer module 312 to coordinate configuration and operation of the duplexer 262 and/or switch 264. Further, it is recognised that the validation module 304 can be used to validate which device 262, 264 is installed in which radio module 210. It is also recognised that the SDR 18 can be configured so that the radio portions 210 are default configured as TDD unless there is a plug-in FDD detected (via the programmable system 202) and then the radio portions 210 would be dynamically configured for FDD operation.

The proposed architecture of the SDR 18 separates Tx and Rx paths completely. Since there can be 4 RF bands, there can be 4 RF connectors on the board. With such a design, the FDD and HFDD support is also achieved by introducing an external duplexer connection to two of the RF connectors on the board. The connection to different connectors is established via RF switches.

### Support for Public Safety

The public safety frequency bands are also supported by the SDR 18 so that the SDR 18 can be used for public safety and the government services like airport security, homeland security etc. The mode of operation can either be set through the cognitive engine 222 or by remotely configuring the SDR 18. Once the public safety mode is ON, the engine 222 gives priority to public safety stations traffic signals by employing a special authorization algorithm coordinated by a priority module 314. It is recognised that the priority module 314 in general operation (for safety signals or not) can distinguish certain signals (e.g. via the respective radio portion 210 that they are received on or generated for) and then configure the SDR 18 via the workflow module 310 to give priority processing to the distinguished priority signal.

### Pre-Distortion Without Additional HW in TDD Mode

The proposed architecture of the SDR 18 can also employ pre-distortion implementation in TDD mode without additional hardware components. Since during transmission of state of a TDD system the receiver path 240 is idle, the receiver path 240 can be used to couple the transmitted signal and is brought back into the digital domain. By using this signal, the transmitted signal is pre-distorted. With this implementation the additional cost of a coupler, downconversion units, and ADC can be eliminated. This can result in a lower cost simple design with more board space remaining.

### Scalability as Use of a Repeater

The existence of potential multiple radio modules 210 on the same RF platform 208 can enables the SDR 18 to be used as a repeater either for the same frequency or converting to a different frequency. This is facilitated by the separate transmitter 242 and receiver 240 paths, and can be configured to supports both TDD and FDD.

This technology/protocol translation is also supported through the baseband processing system 202 via the appropriate modules 300-314 for monitoring/controlling processing and routing of the signals 20a,b the various stages through the SDR 18. Example technology/protocols for this repeater functionality are such as but not limited to: WiMAX; LTE; and UMB translation, such that all of these technology/protocols are based on a common architecture (OFDM).

### Computing Devices 101

Referring to FIGS. 1 and 15, each of the above-described components of the environment 10, i.e. the signal source/target 12, the devices 16,17 coupled to or hosting the SDR 18, the SDR itself if separate from the devices 16,17, and the third party 14 can be implemented on one or more respective computing device(s) 101. The devices 101 in general can include a network connection interface 400, such as a network interface card or a modem or in the case of the SDR the RF front end 208, coupled via connection 418 to a device infrastructure 404. The connection interface 400 is connectable during operation of the devices 101 to the network 11 (e.g. a wireless intranet/extranet), which enables the devices 101 to communicate with each other as appropriate. The network 11 can support the communication of the signals 20 between the components of the environment 10.

Referring again to FIG. 15, the devices 101 can also have a user interface 402, coupled to the device infrastructure 404 by connection 422, to interact with a user (e.g. user of the SDR 18, devices 16,17 or the administrator 14, etc.). The user interface 402 is used by the user of the device 101 to interact with the data contained within the signals 20a,b and to operate the SDR 18. The user interface 402 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 404. For the devices 101 used by the administrator 14, the user interfaces 402 can be used to associate (e.g. manually or automated through association software—e.g. applications 207) reconfiguration data 22 with the SDRs 18, as further described above.

Referring again to FIG. 15, operation of the devices 101 is facilitated by the device infrastructure 404. The device infrastructure 404 includes one or more computer processors 408 (e.g. blocks 220) and can include an associated memory 410 (e.g. a random access memory). The computer processor 408 facilitates performance of the device 101 configured for the intended task through operation of the network interface 400, the user interface 402 and other application programs/hardware 407 (e.g. the engine 222 of the SDR 18) of the device 101 by executing task related instructions. These task related instructions can be provided by an operating system, and/or software applications 407 located in the memory 410, and/or by operability that is configured into the electronic/digital circuitry of the processor(s) 408 designed to perform the specific task(s). Further, it is recognized that the device infrastructure 404 can include a computer readable storage medium 412 coupled to the processor 408 for providing instructions to the processor 408 and/or to load/update application programs 407 (e.g. configuration data 22). The computer readable medium 412 can include hardware and/or software such as, by way of example only, magnetic disks, magnetic tape, optically readable medium such as CD/DVD ROMS, and memory cards. In each case, the computer readable medium 412 may take the form of a small disk, floppy diskette, cassette, hard disk drive, solid-state memory card, or RAM provided in the memory module 410. It should be noted that the above listed example computer readable mediums 412 can be used either alone or in combination. The device memory 410 and/or computer readable medium 412 can be used to store the protocols and associated plug-in identifications of the device 101.

Further, it is recognized that the computing devices 101 can include the executable applications 407 comprising code or machine readable instructions for implementing predetermined functions/operations including those of an operating system and the programmable system 202, for example. The processor 408 as used herein is a configured device and/or set of machine-readable instructions for performing operations as described by example above. As used herein, the processor 408 may comprise any one or combination of, hardware, firmware, and/or software (e.g. modules 300-314). The processor 408 acts upon information by manipulating, analyzing, modifying, converting or transmitting information for use by an executable procedure or an information device, and/or by routing the information with respect to an output device. The processor 408 may use or comprise the capabilities of a controller or microprocessor, for example. Accordingly, any of the functionality of the engine 22 (e.g. modules 300-314, and subset thereof may be implemented in hardware, software or a combination of both. Accordingly, the use of a processor 408 as a device and/or as a set of machine-readable instructions is hereafter referred to generically as a processor/module for sake of simplicity. Further, it is recognised that the SDR 18 can include one or more of the computing devices 101 (comprising hardware and/or software) for implementing the modules 310-314 or functionality subset thereof, as desired.

It will be understood that the computing devices 101 of the devices 16,17 may be, for example, personal computers, personal digital assistants, mobile phones, and/or base stations. Server computing devices 101 (e.g. of the administrator 14) can be configured as desired. Further, it is recognised that each computing device 101, although depicted as a single computer system, may be implemented as a network of computer processors, as desired.

Further, it is recognised that the modules 220,300,302,304,306,308,309,310,312,314 can be configured to operate interactively as shown, the operations/functionality of the selected modules 220,300,302,304,306,308,309,310,312,314 can be combined or the operations/functionality of the selected modules 220,300,302,304,306,308,309,310,312,314 can be further subdivided, as desired. Further, it is recognised that the modules 220,300,302, 304,306,308,309,310,312,314 can communicate or otherwise obtain their calculated results from one another or can store their respective calculated results in the storage 410 for subsequent retrieval by another module 220,300,302,304,306,308,309,310,312,314 there-from. It is also recignised that there may be more than one memory 410 used by associated modules 220,300,302,304,306,308,309,310,312,314, as desired.

### Operation 500 of the SDR 18

Referring to FIG. 16, shown is an example transmission operation of the SDR 18 of FIG. 3. At step 501, the filter components 200 are releasably connected to their corresponding connectors 250,260 (see FIG. 6). At step 502, the system 202 configures operation of the SDR through dynamically recognizing frequency characteristics of the modular IF filter component 212 and the modular RF filter component 214 from corresponding filter identification information 255 (see FIG. 5). At step 504, digital data 20b is generated (e.g. via the waveform module 300—see FIG. 14) and then processed via the digital processor block 220, such that the digital data represents eventual content of the radio signal 20a. At step 506, the SDR 18 converts the digital data 20b as the content for the corresponding radio signal 20a. At step 508, the radio signal 20a is processed via the IF interface 206 including the modular IF filter component(s) 212, at the selected IF center frequency and channel bandwidth. At step 510 the RF platform 208 receives the processed radio signal 20a from the IF interface 206 and implements further processing of the received radio signal 20a including processing by the modular RF filter components 214 to generate the transmitted signal 20a. The modular RF filter component 214 is used to select the RF sub-band 232 and RF center frequency 234 of the SDR 18 for each of the radio portions 210.

It is recognised that the operation 500 can also be described for firstly releasably connecting the filter components 200, configuring of the SDR 18, and then performing the reverse operation of the transmission procedure as described above.

APPENDIX A

| | Spectrum | | |
|---|---|---|---|
| Country | MHz | MHz | BW |
| Korea | 2300 | 2327 | 27 |
| | 2331.5 | 2358.5 | 27 |
| | 2363 | 2390 | 27 |
| Malaysia | 2330 | 2360 | 30 |
| | 2360 | 2390 | 30 |
| | 2300 | 2330 | 30 |
| | 2375 | 2400 | 25 |
| | 2528 | 2540 | 12 |
| | 2648 | 2660 | 12 |
| | 2600 | 2612 | 12 |
| | 2504 | 2516 | 12 |
| | 2624 | 2636 | 12 |
| | 2552 | 2564 | 12 |
| | 2612 | 2624 | 12 |
| | 2678 | 2688 | 10 |
| USA | | | |
| 2.3G | 2305 | 2310 | 5 |
| | 2350 | 2355 | 5 |
| | 2310 | 2315 | 5 |
| | 2355 | 2360 | 5 |
| | 2315 | 2320 | 5 |
| | 2345 | 2350 | 5 |
| | 2305 | 2320 | 15 |
| | 2345 | 2360 | 15 |
| 2.5G | 2496 | 2502 | 6 |
| | 2596 | 2602 | 6 |
| | 2608 | 2614 | 6 |
| | 2618 | 2624 | 6 |
| | 2624 | 2629 | 5 |
| | 2629 | 2635 | 6 |
| | 2635 | 2640 | 5 |
| | 2620 | 2626 | 6 |
| | 2632 | 2638 | 6 |
| | 2602 | 2608 | 6 |
| | 2614 | 2620 | 6 |
| | 2626 | 2632 | 6 |
| | 2638 | 2644 | 6 |
| | 2640 | 2646 | 6 |
| | 2646 | 2651.5 | 5.5 |
| | 2650 | 2656 | 6 |
| | 2651 | 2657 | 6 |
| | 2657 | 2662 | 5 |
| | 2662 | 2668 | 6 |
| | 2668 | 2673 | 5 |
| | 2674 | 2680 | 6 |
| Canada | 2500 | 2596 | 96 |
| | 2596 | 2686 | 90 |
| | 2535 | 2568 | 33 |
| | 2657 | 2690 | 33 |
| Indonesia | 2500 | 2520 | 20 |
| | 2670 | 2690 | 20 |
| Mexico | 2500 | 2690 | 190 |

APPENDIX B
SDR
Channelization

| | | | | Bandwidth | | | | | | | | | | |
|---|---|---|---|---|---|---|---|---|---|---|---|---|---|---|
| Low | High | | | 1.25 | 1.75 | 3 | 3.5 | 6 | 6.7 | 8 | 12 | 14 | 20 | 28 |
| limit | limit | Range | F Center | Number of Channels | | | | | | | | | | |
| MHz | MHz | MHz | MHz | Available | | | | | | | | | | |
| 698 | 806 | 108 | 752 | 86 | 61 | 36 | 30 | 18 | 16 | 13 | 9 | 7 | 5 | 3 |
| 2300 | 2700 | 400 | 2500 | 320 | 228 | 133 | 114 | 66 | 59 | 50 | 33 | 28 | 20 | 14 |
| 3300 | 3800 | 500 | 3550 | 400 | 285 | 166 | 142 | 83 | 74 | 62 | 41 | 35 | 25 | 17 |
| 5725 | 5850 | 125 | 5787.5 | 100 | 71 | 41 | 35 | 20 | 18 | 15 | 10 | 8 | 6 | 4 |

APPENDIX C
FILTERS TO BE USED FOR SDR-MB PLUG-IN FILTERS

| | | | | pass | | |
|---|---|---|---|---|---|---|
| | Center | Pass | | band | | |
| | Freq at | band | Insertion | level | | |
| | room | (spec) | loss max | [dB] | | |
| | temp. | [Mhz] | [dB] | (spec) | Package | How Driven |
| Filter | | | | | | |
| TFS44S | 44 | 2 | 16 | 1.5 | 13 × 6 6P PCB | single-balanced |
| TFS44T | 44 | 3 | 16 | 1.5 | 13 × 6 6P PCB | single-balanced |
| TFS44U | 44 | 5 | 16 | 1.5 | 13 × 6 6P PCB | single-balanced |
| TFS44V | 44 | 8 | 16 | 1.5 | 13 × 6 6P PCB | single-balanced |
| 2nd IF filters = 70 MHZ | | | | | | |
| TFS70H11 | 70 | 6.50 | 23.0 | 1 | 22 × 13 metal | single-single |
| TFS70H12 | 70 | 7.20 | 23.0 | 0.8 | 22 × 13 metal | single-single |
| TFS70H13 | 70 | 7.60 | 24.0 | 1 | 22 × 13 metal | single-single |
| TFS70H14 | 70 | 8.00 | 25.0 | 1 | 22 × 13 metal | single-single |
| TFS70H16 | 70 | 9.10 | 26.0 | 1 | 22 × 13 metal | single-single |
| TFS70H17 | 70 | 9.00 | 26.0 | 1 | 22 × 13 metal | single-single |
| TFS70H22 | 70 | 0.31 | 24.0 | 1 | 22 × 13 metal | single-single |
| TFS70H26A | 70 | 1.80 | 26.0 | 1 | 22 × 13 metal | single-single |
| TFS70H28 | 70 | 2.50 | 26.0 | 1 | 22 × 13 metal | single-single |
| TFS70H29A | 70 | 3.00 | 26.0 | 1 | 22 × 13 metal | single-single |
| TFS70H313 | 70 | 17.60 | 26.0 | 1 | 22 × 13 metal | single-single |
| TFS70H311 | 70 | 15.00 | 25.0 | 3 | 22 × 13 metal | single-single |
| TFS70H312 | 70 | 15.00 | 26.0 | 1 | 22 × 13 metal | single-single |
| TFS70H314 | 70 | 19.30 | 27.0 | 1 | 22 × 13 metal | single-single |
| TFS70H32 | 70 | 4.00 | 26.0 | 1 | 22 × 13 metal | single-single |
| TFS70H33 | 70 | 4.50 | 26.0 | 1 | 22 × 13 metal | single-single |
| TFS70H35 | 70 | 5.60 | 25.0 | 1 | 22 × 13 metal | single-single |
| TFS70H37 | 70 | 11.00 | 24.0 | 1 | 22 × 13 metal | single-single |
| TFS70H38 | 70 | 11.60 | 25.0 | 1 | 22 × 13 metal | single-single |
| TFS70H41 | 70 | 20.60 | 23.0 | 1 | 22 × 13 metal | single-single |
| TFS70H43 | 70 | 24.50 | 25.0 | 1 | 22 × 13 metal | single-single |
| TFS70H44 | 70 | 25.60 | 27.5 | 1 | 22 × 13 metal | single-single |
| TFS70L | 70 | 7.80 | 27.0 | 1 | 22 × 13 metal | single-single |
| TFS70Q | 70 | 15.00 | 22.0 | 3 | 22 × 13 metal | BDT single- |
| | | | | | | single |
| 1st IF Filters = 456 MHz | | | | | | |
| TFS456M | 456 | 6.80 | 13.0 | 1 | 7 × 5 10P LCC | SPUDT |
| | | | | | | balanced- |
| | | | | | | balanced |
| TFS456P | 456 | 1.58 | 10.0 | 1 | 7 × 5 10P LCC | SPUDT single- |
| | | | | | | single |
| TFS456S | 456 | 4.60 | 13.7 | 1 | 7 × 5 10P LCC | SPUDT single- |
| | | | | | | single |
| TFS456T | 456 | 9.10 | 12.0 | 1 | 7 × 5 10P LCC | SFIT balanced- |
| | | | | | | balanced |
| TFS456U | 456 | 11.60 | 14.0 | 1.5 | 7 × 5 10P LCC | SPUDT single- |
| | | | | | | single |
| TFS456V | 456 | 4.60 | 13.7 | 1 | 7 × 5 10P LCC | SPUDT |
| | | | | | | balanced- |
| | | | | | | balanced |
| TFS456X | 456 | 9.10 | 12.0 | 1 | 7 × 5 10P LCC | SPUDT |
| | | | | | | balanced- |
| | | | | | | balanced |
| TFS456Y | 456 | 4.60 | 13.7 | 1 | 7 × 5 10P LCC | SPUDT |
| | | | | | | balanced- |
| | | | | | | balanced |
| RF Filters = 700 MHz | | | | | | |
| 3CKB10- | 698.3 | 55.5 | 1.82 | | 12.7 × 12.7 × 10 | |
| 700*/T50-1.1 | | | | | 3p | |
| 3CKB10- | 723.3 | 55.5 | 1.86 | | 12.7 × 12.7 × 10 | |
| 725*/T50-1.1 | | | | | 3p | |
| 3CKB10- | 748.4 | 55.5 | 1.92 | | 12.7 × 12.7 × 10 | |
| 750*/T50-1.1 | | | | | 3p | |
| 3CKB10- | 773.4 | 55.5 | 1.95 | | 12.7 × 12.7 × 10 | |
| 775*/T50-1.1 | | | | | 3p | |
| 3CKB10- | 798.5 | 55.5 | 1.99 | | 12.7 × 12.7 × 10 | |
| 800*/T50-1.1 | | | | | 3p | |
| 3CKB10- | 823.5 | 55.5 | 2.04 | | 12.7 × 12.7 × 10 | |
| 825*/T50-1.1 | | | | | 3p | |
| RF Filters = 2.5 GHz | | | | | | |
| MFE2345CCF22 | 2345 | 90 | 2.3 | | 6.7 × 6.5 × 2.1 | |
| | | | | | 3p | |
| MFE2442BBU21 | 2442 | 84 | 1.22 | | 6.7 × 6.5 × 2.1 | |
| | | | | | 3p | |
| MFE2500BBU21 | 2500 | 4 | 2.94 | | 3.8 × 3.4 × 1.9 | |
| | | | | | 3p | |
| MFE2550CCF21 | 2550 | 100 | 1.22 | | 3.6 × 3.2 × 1.7 | |
| | | | | | 3p | |
| MFE2593CCF21 | 2593 | 186 | 0.97 | | 6.7 × 6.5 × 2.1 | |
| | | | | | 3p | |
| MFE2641CCF21 | 2641 | 90 | 0.97 | | 6.7 × 4.2 × 2.1 | |
| | | | | | 3p | |
| RF Filters = 3.5 GHz | | | | | | |
| MFE3350CCA21 | 3350 | 100 | 2.3 | | 6.7 × 6.5 × 2.1 | |
| | | | | | 3p | |
| MFE3400CCA21 | 3400 | 200 | 1.5 | | 6.7 × 5.3 × 2.1 | |
| | | | | | 3p | |
| MFE3450CCA21 | 3450 | 100 | 0.98 | | 6.7 × 5.8 × 2.5 | |
| | | | | | 3p | |
| MFE3550CBA21 | 3550 | 300 | 1.22 | | 6.7 × 4.6 × 2.0 | |
| | | | | | 3p | |
| MFE3500CCA21 | 3500 | 300 | 0.88 | | 6.7 × 5.15 × 2.5 | |
| | | | | | 3p | |
| MFE3600CCA21 | 3600 | 200 | 1.01 | | 6.7 × 5.0 × 2.5 | |
| | | | | | 3p | |
| RF Filters = 5.8 GHz | | | | | | |
| MFE5777BBA21 | 5777 | 100 | 0.9 | | 3.8 × 3.08 × 2.0 | |
| | | | | | 3p | |
| MFE5800BBA21 | 5800 | 100 | 1.31 | | 3.8 × 3.2 × 2.0 | |
| | | | | | 3p | |
| MFE5825BBA21 | 5825 | 200 | 1.27 | | 3.8 × 2.95 × 2.0 | |
| | | | | | 3p | |

We claim:

1. A software defined radio (SDR) for communicating a plurality of radio signals over a wireless communications network, the radio comprising:
a programmable system having a plurality of digital processors for processing digital data representing a digital form of the plurality of radio signals, the programmable system also for configuring operation of radio hardware for processing of the radio signals themselves;
a configurable intermediate frequency (IF) interface for processing the plurality of radio signals for subsequent processing as the digital data communicated to the programmable system and the digital data received from the programmable system, the IF interface having a first connector for releasably connecting a modular IF filter component for use in the processing of said plurality of radio signals, the modular IF filter component being part of the radio hardware for selecting an IF center frequency and channel bandwidth of the SDR; and
an RF platform coupled to the IF interface and configured for having with at least one radio portion, each radio portion for receiving and transmitting the radio signal over the communications network on behalf of the IF interface, said each radio portion having a second connector for releasably connecting a modular RF filter component for use in the processing of said plurality of radio signals, the modular RF filter component being part of the radio hardware for selecting an RF sub-band and RF center frequency of said each radio module;
wherein the programmable system is adapted to configure operation of the SDR through recognition of the corresponding connected modular RF and IF filters.

2. The SDR of claim 1, wherein the SDR has a plurality of the RF platforms and each of the RF platforms has a plurality of the radio portions.

3. The SDR of claim 2, wherein each of the RF platforms has a plurality of different combinations of the RF sub-band and RF center frequency for the corresponding plurality of radio portions of said each of the RF platforms.

4. The SDR of claim 2, wherein the programmable system is configured for automatic recognition of the connected modular RF filter component of at least one of the radio portions through communication with a digital unit of the second connector that is adapted to access RF filter identification information associated with the connected modular RF filter component.

5. The SDR of claim 2, wherein the programmable system is configured for automatic recognition of the connected modular IF filter component of IF interface through communication with a digital unit of the first connector that is adapted to access IF filter identification information associated with the connected modular IF filter component.

6. The SDR of 2 further comprising a third connector of said each radio portion for releasably connecting a corresponding duplexer component for use in the processing of said plurality of radio signals.

7. The SDR of claim 6, wherein the programmable system is configured for automatic recognition of the connected duplexer component through communication with a digital unit of the third connector that is adapted to access duplexer identification information associated with the connected duplexer component.

8. The SDR of claim 2 further comprising a transmission path and a receiver path of the IF interface, such that the transmission path and the receiver path are separate from one another.

9. The SDR of claim 2, wherein said each radio platform has a plurality of the second connectors for releasably connecting a corresponding plurality of the modular RF filter components.

10. The SDR of claim 9, wherein the IF interface has a plurality of the first connectors for releasably connecting a corresponding plurality of the modular IF filter components.

11. The SDR of claim 2, wherein the programmable system 202 is configured to give processing priority to communicated public safety signals via a selected public safety mode.

12. The SDR of claim 8, wherein the separated transmission and receiver paths are used to implement pre-distortion processing.

13. The SDR of claim 2, wherein the programmable system is configured to receive a signal on one of the radid portions and to subsequently transmit a corresponding signal on another of the radio portions.

14. The SDR of claim 13, wherein the one of the radio portions and the another of the radio portions are on different ones of the RF platforms.

15. A software defined radio (SDR) method for communicating a plurality of radio signals over a wireless communications network, the method comprising:
configuring operation of the SDR through dynamically recognizing frequency characteristics of a modular IF filter component and a modular RF filter component from corresponding filter identification information;
generating digital data through a programmable system having a plurality of digital processors, the digital data for representing eventual content of a radio signal, the programmable system configured for operation of radio hardware for processing of the radio signal;
converting the digital data as content for the corresponding radio signal;
processing the radio signal though the modular IF filter component, the modular IF filter component being part of the radio hardware for selecting an IF center frequency and channel bandwidth of the SDR and being releasably connected to a first connector;
receiving the processed radio signal from the modular IF filter component and implementing further processing of the received radio signal through the modular RF filter component to generate a transmission signal, the modular RF filter component being part of the radio hardware for selecting an RF sub-band and RF center frequency of the SDR being releasably connected to a second connector; and
communicating the transmission signal to the communication network.

16. A digital system for configuring a software defined radio (SDR) adaptable for communicating a radio signal over a communications network, the SDR adaptable for having a plurality of radio portions and an IF interface, each of the radio portions adapted to select an RF sub-band and RF center frequency by a connector for releasable securing a corresponding modular RF filter component, the IF interface having at least one an IF bandwidth and IF center frequency compatible with the selected RF sub-band and the selected RF center frequency, the system comprising:
a workflow engine module configured for coordinating operation of a programmable system coupled to the IF interface, the programmable system adaptable to operate the IF interface and the radio portions and to digitally process digital data communicated with the IF interface;
a validation module configured for confirming that modular RF filter component after being connected has an acceptable RF sub-band and RF center frequency;
a protocol module adapted to configure the SDR for use of a communications protocol compatible with the validated modular RF filter component; and
an identification module configured for monitoring which of the plurality of radio portions corresponds with the communicated radio signal.
